(19) United States
(12) Patent Application Publication
(10) Pub. No.: US 2023/0123927 A1
(43) Pub. Date: Apr. 20, 2023

(54) DAIRY PRODUCTS AND PROCESSES

(71) Applicant: Fonterra Co-Opertive Group Limited, Auckland (NZ)

(72) Inventors: Nicola Jane Robertson, Auckland (NZ); Aurélie Suzanne Bernadette Leneveu, Auckland (NZ); Hongping Gao, Auckland (NZ); David Francis Elgar, Auckland (NZ)

(21) Appl. No.: 17/907,246

(22) PCT Filed: Apr. 1, 2021
(86) PCT No.: PCT/IB2021/052717

§ 371 Date: Sep. 23, 2022

(30) Foreign Application Priority Data
Apr. 1, 2020 (NZ) 763173

(51) Int. Cl. A23L 2/66; A23J 3/08; A23L 33/19; A23L 2/46; A23L 33/115; A23L 33/125; A23G 9/04; A23G 9/38; A23G 9/32; A23G 9/34

(52) U.S. Cl. CPC A23L 2/66; A23J 3/08; A23L 33/19; A23L 2/46; A23L 33/115; A23L 33/125; A23G 9/045; A23G 9/38; A23G 9/327; A23G 9/34; A23V 2002/00

(57) ABSTRACT

The disclosure relates to a method of making a beverage comprising a milk protein concentrate (MPC), a beverage comprising an MPC, an MPC or use of a MPC. More particularly, this disclosure relates to treatment of an MPC to allow for heat homogenisation of a beverage containing the MPC, while reducing occurrence of malodour and/or egg-type or sulphur-type smell and/or taste.

This disclosure relates to a method of making a beverage comprising a milk protein concentrate (MPC), a beverage comprising an MPC, an MPC, or use of an MPC. More particularly, this disclosure relates to treatment of an MPC to allow for heat homogenisation of a beverage containing the MPC, while reducing occurrence of malodour and/or egg-type or sulphur-type smell and/or taste.

### BACKGROUND ART

Milk protein concentrates (MPCs) are a valuable source of protein. MPCs can be used in beverages, for example for consumers wishing to maintain/gain or lose weight or muscle. However, care must be taken in processing or making such beverages as proteins, particularly the desirable whey proteins, can be unstable under some processing conditions.

WO2012/008858 describes a liquid nutritional composition comprising (a) 2-25% by weight of a calcium-depleted milk protein concentrate (MPC) that has undergone a heat treatment to at least 80° C. and has between 15-45% by weight of the calcium removed; (b) 0-30% by weight fat; (c) 5-45% by weight carbohydrate; wherein the nutritional composition has a viscosity of less than 200 cP at a temperature of 20° C. and shear rate of 100s⁻¹, and has an energy density of at least 0.5 kcal/mL, and wherein protein provides 10-40% of the total energy content of the composition. Specifically the MPC was heat treated at 90° C. for 4s, which gives a level of whey protein denaturation of approximately 10-20%.

W02004/057971 describes a heat treated and decalcified milk protein concentrate (HY-MPC) that is a calcium-depleted MPC having whey proteins denatured. The denaturation is carried out by heating at a temperature above 65° C. for sufficient time to allow denaturation of whey proteins. The heating is generally carried out at a pH of 6.0-7.0, preferably 6.5-7.0. Preferably, heating is for at least 4 minutes in this embodiment. The decalcified milk protein concentrate is used in a method of manufacture of a substantially nugget-free cheese.

It is an object of this disclosure to provide a method of making a beverage , a beverage and/or a milk protein concentrate which goes at least some way towards overcoming one or more of the problems or difficulties associated with the prior art, or to at least provide the industry/public with a useful choice.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

### SUMMARY

In a first aspect there is provided a method of making a beverage comprising:

(a) combining to make a beverage (i) water and (ii) about 6-20% by weight protein in the form of a milk protein concentrate (MPC) which has been heat treated to denature about 50-100% by weight of the total whey protein; and

(b) homogenising the beverage at a temperature of about 45-98° C.

In a second aspect there is provided a method of making a beverage comprising:

(a) combining to make a beverage (i) water and (ii) about 6-20% by weight protein in the form of a milk protein concentrate (MPC) which has been heat treated to denature about 50-100% by weight of the total whey protein and which has calcium content depleted by about 2-50% by weight; and

(b) homogenising the beverage at a temperature of about 45-98° C.

In a third aspect there is provided a method of making a beverage comprising:

(a) combining to make a beverage (i) water and (ii) about 6-20% by weight protein in the form of a milk protein concentrate (MPC) which has been heat treated to denature about 50-100% by weight of the total whey protein; and

(b) homogenising the beverage at a temperature of about 70-98° C.

In a fourth aspect there is provided a method of making a beverage comprising:

(a) combining to make a beverage (i) water and (ii) about 6-20% by weight protein in the form of a milk protein concentrate (MPC) which has been heat treated to denature about 50-100% by weight of the total whey protein and which has the calcium content depleted by about 2-50% by weight; and

(b) homogenising the beverage at a temperature of about 70-98° C.

For the avoidance of doubt, the following embodiments concerning the homogenisation step may apply to both the aspects above and the aspects below, where applicable in context.

In some embodiments, in step (b) the beverage is homogenised for about 1 second to about 5 minutes. In some embodiments, in step (b) the beverage is homogenised for about 1 second to 3 minutes. In some embodiments, in step (b) the beverage is homogenised for about 1 second to 2 minutes. In some embodiments, in step (b) the beverage is homogenised for about 1 second to 1 minute. In some embodiments, in step (b) the beverage is homogenised for about 15 to 30 seconds.

In some embodiments, the homogenisation is carried out at high pressure.

In some embodiments, the total homogenising pressure is about 100 to about 1000 bars. In some embodiments, the total homogenising pressure is about 100 to about 600 bars. In some embodiments, total homogenising pressure is about 150 to about 500 bars. In some embodiments, total homogenising pressure is about 200 to about 400 bars.

In some embodiments, the homogenising step is at about 50-95° C. In some embodiments the homogenising step is at about 50-90° C°C. In some embodiments the homogenising step is at about 70-95° C. In some embodiments the homogenising step is at about 75-90° C. In some embodiments the homogenising step is at about 80-90° C.

In a fifth aspect there is provided a method of making a beverage comprising:

(a) combining to make a beverage (i) water and (ii) about 6-20% by weight protein in the form of a milk protein concentrate (MPC) which has been heat treated to denature about 50-100% by weight of the total whey protein; and

(b) homogenising the beverage at a temperature of about 70-98° C. where the beverage is to undergo a UHT sterilising step, or homogenising at a temperature of about 45-98° C. where the beverage is to undergo a retort sterilising step.

In a sixth aspect there is provided a method of making a beverage comprising:

(a) combining to make a beverage (i) water and (ii) about 6-20% by weight protein in the form of a milk protein concentrate (MPC) which has been heat treated to denature about 50-100% by weight of the total whey protein and which has the calcium content depleted by about 2-50% by weight; and

(b) homogenising the beverage at a temperature of about 70-98° C. where the beverage is to undergo a UHT sterilising step, or homogenising at a temperature of about 45-98° C. where the beverage is to undergo a retort sterilising step.

In a seventh aspect there is provided a method of making a beverage comprising:

(a) combining to make a beverage (i) water and (ii) about 6-20% by weight protein in the form of a milk protein concentrate (MPC) which has been heat treated to denature about 50-100% by weight of the total whey protein; and

(b) homogenising the beverage at a temperature of about 70-98° C. where the beverage is to undergo a sterilising step at a temperature of about 120 to 150° C. for about 0.1 to 30 seconds, or homogenising at a temperature of about 45-98° C. where the beverage is to undergo a sterilising step at a temperature of at least 90° C. for a least at least 2 minutes.

In an eighth aspect there is provided a method of making a beverage comprising:

(a) combining to make a beverage (i) water and (ii) about 6-20% by weight protein in the form of a milk protein concentrate (MPC) which has been heat treated to denature about 50-100% by weight of the total whey protein and which has the calcium content depleted by about 2-50% by weight; and

(b) homogenising the beverage at a temperature of about 70-98° C. where the beverage is to undergo a sterilising step at a temperature of about 120 to 150° C. for about 0.1 to 30 seconds, or homogenising at a temperature of about 45-98° C. where the beverage is to undergo a sterilising step at a temperature of at least 90° C. for a least at least 2 minutes.

In a ninth aspect there is provided a method of making a beverage comprising:

(a) combining to make a beverage (i) water and (ii) about 6-20% by weight protein in the form of a milk protein concentrate (MPC) which has been heat treated to denature about 50-100% by weight of the total whey protein;

(b) homogenising the beverage at a temperature of 70-98° C.; and

(c) high temperature sterilising the beverage using UHT.

In a tenth aspect there is provided a method of making a beverage comprising:

(a) combining to make a beverage (i) water and (ii) about 6-20% by weight protein in the form of a milk protein concentrate (MPC) which has been heat treated to denature about 50-100% by weight of the total whey protein and which has the calcium content depleted by about 2-50% by weight;

(b) homogenising the beverage at a temperature of 70-98° C.; and

(c) high temperature sterilising the beverage using UHT.

In an eleventh aspect there is provided a method of making a beverage comprising:

(a) combining to make a beverage (i) water and (ii) about 6-20% by weight protein in the form of a milk protein concentrate (MPC) which has been heat treated to denature about 50-100% by weight of the total whey protein;

(b) homogenising the beverage at a temperature of 45-98° C.; and

(c) high temperature sterilising the beverage using retort.

In a twelfth aspect there is provided a method of making a beverage comprising:

(a) combining to make a beverage (i) water and (ii) about 6-20% by weight protein in the form of a milk protein concentrate (MPC) which has been heat treated to denature about 50-100% by weight of the total whey protein and which has the calcium content depleted by about 2-50% by weight;

(b) homogenising the beverage at a temperature of 45-98° C.; and

(c) high temperature sterilising the beverage using retort.

In a thirteenth aspect there is provided a method of making a beverage comprising:

(a) combining to make a beverage (i) water and (ii) about 6-20% by weight protein in the form of a milk protein concentrate (MPC) which has been heat treated to denature about 50-100% by weight of the total whey protein;

(b) homogenising the beverage at a temperature of 70-98° C.; and

(c) high temperature sterilising the beverage at a temperature of about 120 to 150° C. for about 0.1 to 30 seconds.

In a fourteenth aspect there is provided a method of making a beverage comprising:

(a) combining to make a beverage (i) water and (ii) about 6-20% by weight protein in the form of a milk protein concentrate (MPC) which has been heat treated to denature about 50-100% by weight of the total whey protein and which has the calcium content depleted by about 2-50% by weight;

(b) homogenising the beverage at a temperature of 70-98° C;and

(c) high temperature sterilising the beverage at a temperature of about 120 to 150° C. for about 0.1 to 30 seconds.

In a fifteenth aspect there is provided a method of making a beverage comprising:

(a) combining to make a beverage (i) water and (ii) about 6-20% by weight protein in the form of a milk protein concentrate (MPC) which has been heat treated to denature about 50-100% by weight of the total whey protein;

(b) homogenising the beverage at a temperature of 45-98° C.; and

(c) high temperature sterilising the beverage at a temperature of at least 90° C. for at least 2 minutes.

In a sixteenth aspect there is provided a method of making a beverage comprising:

(a) combining to make a beverage (i) water and (ii) about 6-20% by weight protein in the form of a milk protein concentrate (MPC) which has been heat treated to denature about 50-100% by weight of the total whey protein and which has the calcium content depleted by about 2-50% by weight;

(b) homogenising the beverage at a temperature of 45-98° C.; and

(c) high temperature sterilising the beverage at a temperature of at least 90° C. for at least 2 minutes.

For the avoidance of doubt the following embodiments apply to all of the previous aspects and the below aspects where applicable in context.

In some embodiments, the method further comprises a sterilising step which is carried out after step (b).

In some embodiments, the sterilising step comprises heat treating the beverage.

In some embodiments the sterilising step comprises high temperature sterilising.

In some embodiments high temperature sterilisation step is preferably carried out at about 90° C. to about 150° C. for about 0.25 second to about 60 minutes.

In some embodiments the high temperature sterilising step comprises heat treating the beverage at a temperature of at least about 90, 115, 120, 125, 130, 135, 136, 137, 138, 139, 140, 141, 142, 143, 144, 145, 146, 147, 148, 149 or at least about 150° C. for a period of at least about 0.1, 0.5, 1, 2, 3, 4, 5, 6, 7, 8, 9, 10, 12, 15, 20, 30, 40, 50, 60 seconds or at least about 1, 2, 3, 4, 5, 6, 7, 8, 9, 10 or at least about 60 minutes.

In some embodiments the high temperature sterilising step comprises heat treating the beverage at a temperature of at least about 120 to 150, 121 to about 150, 125 to about 150, 130 to about 150, 135 to about 150, 138 to about 150, 121 to about 145, 125 to about 145, 130 to about 145, 135 to about 145, or about 138 to about 145° C. for at least about 0.1 seconds to about 10 minutes, about 0.1 seconds to about 1 minute, about 0.1 s to about 30 seconds, about 0.5 seconds to about 30 seconds, about 1 seconds to about 30 seconds, about 3 seconds to about 30 seconds about 0.1 seconds to about 20 seconds, about 0.5 to about 20 seconds, about 1 to about 20 seconds, about 3 to about 20 seconds, about 0.1 to about 10 seconds, about 1 to about 10 seconds, about 3 to about 10 seconds, about 0.1 to about 7 seconds, about 1 to about 7 seconds, about 3 to about 7 seconds, about 0.1 to about 5 seconds, about 1 to about 5 seconds or about 3 to about 5 seconds.

In some embodiments the high temperature sterilising step comprises heat treating the beverage at a temperature of at least about 115° C. for at least about 2 seconds, at least about 120° C. for at least about 2 seconds, at least about 125° C. for at least about 2 seconds, at least about 130° C. for at least about 1 seconds, at least about 135° C. for at least about 1 seconds, at least about 138° C. for at least about 1 seconds, at least about 130° C. for at least about 3 seconds, at least about 135° C. for at least about 3 seconds, at least about 138° C. for at least about 3 seconds.

In some embodiments the high temperature sterilising step comprises heat treating the beverage at a temperature from about 130 to about 150° C. for at least about 1 seconds, from about 130 to about 150° C. for at least about 3 seconds, from about 135 to about 150° C. for at least about 1 seconds, from about 135 to about 150° C. for at least about 3 seconds, from about 138 to about 145° C. for at least about 1 seconds, from about 138 to about 145° C. for at least about 3 seconds.

In some embodiments the high temperature sterilising step comprises heat treating the beverage at a temperature of at least about 130° C. for about 1 second to about 10 seconds, at least about 135° 5 C for about 1 second to about 10 seconds, at least about 138° C. for about 1 second to about 10 seconds, from about 135 to about 150° C. for about 1 second to about 10 seconds, from about 138 to about 145° C. for about 1 second to about 10 seconds, from about 135 to about 150° C. for about 3 seconds to about 5 seconds, or from about 138 to about 145° C. for about 3 seconds to about 5 seconds.

In some embodiments high temperature sterilising gives an Fo value of at least about 5, or at least about 3. Preferably the heat treatment has an Fo value of at least equivalent to 90° C. for 40minutes, 121.1° C. for 3 minutes, 130° C. for 25 seconds, 140° C. for 2.5 seconds or 150° C. for 0.25 seconds.

In some embodiments the high temperature sterilising is carried out by UHT or retort.

In some embodiments the high temperature sterilising step comprises UHT heat treating the beverage at a temperature of about 120 to 150° C. for about 0.1 seconds to about 30 seconds. In some embodiments the high temperature sterilising step comprises UHT heat treating the beverage at a temperature of about 120 to 150° C. for about 0.5 seconds to about 30 seconds. In some embodiments the high temperature sterilising step comprises UHT heat treating the beverage at a temperature of about 120 to 150° C. for about 1 seconds to about 30 seconds. In some embodiments the high temperature sterilising step comprises UHT heat treating the beverage at a temperature of about 120 to 150° C. for about 3 seconds to about 30 seconds. In some embodiments the high temperature sterilising step comprises UHT heat treating the beverage at a temperature of about 120 to 150° C. for about 1 to about 10 seconds. In some embodiments the high temperature sterilising step comprises UHT heat treating the beverage at a temperature of about 120 to 150° C. for about 3 to about 10 seconds. In some embodiments the high temperature sterilising step comprises UHT heat treating the beverage at a temperature of about 120 to 150° C. for about 0.1 to about 7 seconds. In some embodiments the high temperature sterilising step comprises UHT heat treating the beverage at a temperature of about 120 to 150° C. for about 1 to about 7 seconds. In some embodiments the high temperature sterilising step comprises UHT heat treating the beverage at a temperature of about 120 to 150° C. for about 3 to about 7 seconds. In some embodiments the high temperature sterilising step comprises UHT heat treating the beverage at a temperature of about 120 to 150° C. for about 0.1 to about 5 seconds. In some embodiments the high temperature sterilising step comprises UHT heat treating the beverage at a temperature of about 120 to 150° C. for about 1 to about 5 seconds. In some embodiments the high temperature sterilising step comprises UHT heat treating the beverage at a temperature of about 120 to 150° C. for about 3 to 5 seconds.

In some embodiments the high temperature sterilising step comprises UHT heat treating the beverage at a temperature of about 140 to 150° C. for about 3 to 6 seconds.

In some embodiments the high temperature sterilising step comprises retort heat treating the beverage at a temperature of at least 90° C. for at least 2 minutes. In some embodiments the high temperature sterilising step comprises retort heat treating the beverage at a temperature of at least 90° C. for a least at least 5 minutes. In some embodiments the high temperature sterilising step comprises retort heat treating the beverage at a temperature of at least 90° C. for a least at least 10 minutes. In some embodiments the high temperature sterilising step comprises retort heat treating the beverage at a temperature of at least 115° C. for a least at least 2 minutes. In some embodiments the high temperature sterilising step comprises retort heat treating the beverage at a temperature of at least 115° C. for a least at least 5 minutes. In some embodiments the high temperature sterilising step comprises retort heat treating the beverage at a temperature of at least 115° C. for a least at least 10 minutes.

In some embodiments the high temperature sterilising step comprises retort heat treating the beverage at a temperature of about 120 to 150° C. for a least at least 5 minutes. In some embodiments the high temperature sterilising step comprises retort heat treating the beverage at a temperature of about 120 to 150° C. for a least at least 10 minutes.

In some embodiments the high temperature sterilising step comprises retort heat treating the beverage at a temperature of about 105 to 150° C. for about 5 to 60 minutes, about 105 to 150° C. for about 5 to 45 minutes, about 105 to 150° C. for about 5 to 30 minutes. In some embodiments the high temperature sterilising step comprises retort heat treating the beverage at a temperature of about 105 to 145° C. for about 5 to 60 minutes, about 105 to 145° C. for about 5 to 45 minutes, about 105 to 145° C. for about 5 to 30 minutes. In some embodiments the high temperature sterilising step comprises retort heat treating the beverage at a temperature of about 110 to 145° C. for about 5 to 60 minutes, about 110 to 145° C. for about 5 to 45 minutes, about 110 to 145° C. for about 5 to 30 minutes. In some embodiments the high temperature sterilising step comprises retort heat treating the beverage at a temperature of about 120 to 130° C. for about 5 to 60 minutes, about 120 to 130° C. for about 5 to 45 minutes, about 120 to 130° C. for about 5 to 30 minutes. In some embodiments the high temperature sterilising step comprises retort heat treating the beverage at a temperature of about 120 to 130° C. for about 10 to 20 minutes.

In some embodiments the beverage has less egg-type or sulphur-type smell and/or taste compared to a beverage made with an MPC that has not been heat treated.

In some embodiments the beverage has less egg-type or sulphur-type smell and/or taste compared to a beverage made with an MPC that has not been heat treated to denature about 50-100% by weight of the total whey protein.

In some embodiments the beverage has less egg-type or sulphur-type smell and/or taste compared to a beverage made with an MPC that has not been heat treated to denature about 50-100% by weight of the total whey protein.

In some embodiments the beverage has less egg-type or sulphur-type smell and/or taste compared to a beverage made with an MPC that has not been heat treated to denature about 50-100% by weight of the total whey protein and has not been calcium depleted by about 2-50% by weight.

In some embodiments the less egg-type or sulphur-type smell and/or taste is on initial opening of container containing beverage.

In some embodiments, a further homogenizing step is carried out after the sterilising step.

In some embodiments, the further homogenizing step is carried out under aseptic conditions.

In some embodiments, the method further comprises cooling the sterilised beverage under aseptic conditions and aseptically packing the cooled beverage.

In some embodiments, the method further comprises freezing the beverage to make a frozen confectionary.

In some embodiments, about 6-18% by weight protein is combined. In some embodiments, about 6-16% by weight protein is combined. In some embodiments, about 8-16% by weight protein is combined. In some embodiments, about 10-16% by weight protein is combined. Alternatively, in some embodiments about 8-18% by weight protein is combined. In some embodiments about 10-18% by weight protein is combined.

In some embodiments, the MPC has about 70-100% denatured whey protein. In some embodiments, the MPC has about 80-90% denatured whey protein.

In some embodiments, the MPC is about 2-50% by weight calcium depleted. In some embodiments, the MPC has about 5-50% by weight calcium depletion. In some embodiments, the MPC has about 5-45% by weight calcium depletion. In some embodiments, the MPC has about 5-30° k by weight calcium depletion. In some embodiments, the MPC has about 5-20% by weight calcium depletion. In some embodiments, the MPC has about 10-45% by weight calcium depletion. In some embodiments, the MPC has about 10-20% by weight calcium depletion. In some embodiments, the MPC has about 10-15% by weight calcium depletion.

In some embodiments, calcium content of the MPC is about 2.1 to 1.1%w/w of calcium. In some embodiments, calcium content of the MPC is about 2.1 to 1.8%w/w of calcium.

In some embodiments, the MPC has about 2.0-2.6 g of calcium per 100 g of protein. In some embodiments, the MPC has about 2.2-2.6 g of calcium per 100 g of protein, about 2.3-2.6 g of calcium per 100 g of protein, about 2.3-2.5 g of calcium per 100 g of protein, about 2.4-2.5 g of calcium per 100 g of protein.

In some embodiments, the method further comprises the addition of fat to the beverage. In some embodiments, the method further comprises the addition of fat such that the beverage is about 0.1-15% w/w fat. In some embodiments, the method further comprises the addition of fat such that the beverage is about 0.5-10% w/w fat.

In some embodiments the fat is oil. In some embodiments the oil is vegetable oil.

In some embodiments, the method further comprises the addition of carbohydrate to the beverage. In some embodiments, the method further comprises the addition of carbohydrate such that the beverage is about 0.1-45% w/w carbohydrate. In some embodiments, the method further comprises the addition of carbohydrate such that the beverage is about 0.5-45% w/w carbohydrate. In some embodiments the method further comprises the addition of carbohydrate such that the beverage is about 0.5 to 30% w/w carbohydrate. In some embodiments the method further comprises the addition of carbohydrate such that the beverage is about 1% to 30% w/w carbohydrate. Alternatively, in some embodiments the method further comprises the addition of carbohydrate such that the beverage is about 20-30% w/w carbohydrate.

In some embodiments the carbohydrate is sucrose and/or maltodextrin. In some embodiments the carbohydrate is sucrose and maltodextrin.

In some embodiments, the method further comprises the addition of an emulsifier.

In some embodiments, about 0.01 to about 2% w/w emulsifier. In some embodiments, about 0.05-2% w/w emulsifier. In some embodiments, about 0.1-1% w/w emulsifier.

In some embodiments, the emulsifier is the selected from any one or more of mono- and di-glycerides, polysorbate (for example Tween 20, 40, 60 or 80), phospholipids (e.g. lecithin) or dairy derived phospholipid, citric acid esters of mono- and diglycerides of fatty acids (CITREM), sucrose esters of fatty acids, starch sodium octenyl succinate, mono- and di-acetylated tartaric acid esters of mono- and diglycerides (DATEM), sodium stearoyl lactylate (SSL), ethoxylated mono- and diglycerides, propylene glycol mono- and diesters of fats and fatty acids (PGME), glyceryl-lacto esters of fatty acids (LACTEM). In some embodiments the emulsifier is DATEM.

In some embodiments the fat, carbohydrate and/or emulsifier are added prior to step (b). In some embodiments the fat, carbohydrate and/or emulsifier are added in step (a).

In some embodiments, the pH of the beverage is adjusted to between about 6 to about 8. In some embodiments the pH is adjusted after the homogenising step.

In a seventeenth aspect there is provided a beverage comprising (a) about 6-20% by weight protein in the form of a milk protein concentrate (MPC) which has undergone a heat treatment during its manufacture to denature about 50-100% by weight of whey protein in the MPC (b) 0-30% by weight fat (c) 0.1-45% by weight of carbohydrate; and
wherein the beverage has undergone a homogenisation step at a temperature of about 45-98° C.

In an eighteenth aspect there is provided a beverage comprising (a) about 6-20% by weight protein in the form of a milk protein concentrate (MPC) which has undergone a heat treatment during its manufacture to denature about 50-100% by weight of whey protein in the MPC and has had the calcium content in the MPC depleted by about 2-50% by weight and (b) 0-30% by weight fat (c) 0.1-45% by weight of carbohydrate; and wherein the beverage has undergone a homogenisation step at a temperature of about 70-98° C.

For the avoidance of doubt the following embodiments concerning the beverage may apply to the beverage aspects above and the aspects below, where applicable in context.

In some embodiments, the beverage has undergone a homogenisation step for about 1 second to about 5 minutes. In some embodiments, the beverage has undergone a homogenisation step for about 1 second to 3 minutes. In some embodiments, the beverage has undergone a homogenisation step for about 1 second to 2 minutes. In some embodiments, the beverage has undergone a homogenisation step for about 1 second to 1 minute. In some embodiments, the beverage has undergone a homogenisation step for about 15 to 30 seconds.

In some embodiments, the beverage has undergone a homogenisation step at high pressure.

In some embodiments, the beverage has undergone a homogenisation step at a pressure of about 100 to about 1000 bars. In some embodiments, the beverage has undergone a homogenisation step at a pressure of about 100 to about 600 bars. In some embodiments, the beverage has undergone a homogenisation step at a pressure of about 150 to about 500 bars. In some embodiments, the beverage has undergone a homogenisation step at a pressure of about 200 to about 400 bars.

In some embodiments, the beverage has undergone a homogenisation step at about 50-95° C. In some embodiments, the beverage has undergone a homogenisation step at about 50-90° C. In some embodiments, the beverage has undergone a homogenisation step at about 70-95° C. In some embodiments, the beverage has undergone a homogenisation step at about 75-90° C. In some embodiments, the beverage has undergone a homogenisation step at about 80-90° C.

In a nineteenth aspect there is provided a beverage comprising (a) about 6-20% by weight protein in the form of a milk protein concentrate (MPC) which has undergone a heat treatment during its manufacture to denature about 50-100% by weight of whey protein in the MPC (b) 0-30% by weight fat (c) 0.1-45% by weight of carbohydrate; and

wherein the beverage has undergone a homogenisation step at a temperature of about 70-98° C. where the beverage is to undergo a UHT sterilising step, or undergone a homogenisation step at a temperature of 45-98° C. where the beverage is to undergo a retort sterilising step.

In a twentieth aspect there is provided a beverage comprising (a) about 6-20% by weight protein in the form of a milk protein concentrate (MPC) which has undergone a heat treatment during its manufacture to denature about 50-100% by weight of whey protein in the MPC and has had the calcium content in the MPC depleted by about 2-50% by weight and (b) 0-30% by weight fat (c) 0.1-45% by weight of carbohydrate; and

wherein the beverage has undergone a homogenisation step at a temperature of about 70-98° C. where the beverage is to undergo a UHT sterilising step, or undergone a homogenisation step at a temperature of 45-98° C. where the beverage is to undergo a retort sterilising step.

In a twenty first aspect there is provided a beverage comprising (a) about 6-20% by weight protein in the form of a milk protein concentrate (MPC) which has undergone a heat treatment during its manufacture to denature about 50-100% by weight of whey protein in the MPC (b) 0-30% by weight fat (c) 0.1-45% by weight of carbohydrate; and

wherein the beverage has undergone a homogenisation step at a temperature of about 70-98° C. where the beverage is to undergo a sterilising step at about 120 to 150° C. for about 0.1 to 30 seconds, or undergone a homogenisation step at a temperature of 45-98° C. where the beverage is to undergo a sterilising step at least 90° C. for a least at least 2 minutes.

In a twenty second aspect there is provided a beverage comprising (a) about 6-20% by weight protein in the form of a milk protein concentrate (MPC) which has undergone a heat treatment during its manufacture to denature about 50-100% by weight of whey protein in the MPC and has had the calcium content in the MPC depleted by about 2-50° k by weight and (b) 0-30% by weight fat (c) 0.1-45% by weight of carbohydrate; and

wherein the beverage has undergone a homogenisation step at a temperature of about 70-98° C. where the beverage is to undergo a sterilising step at about 120 to 150° C. for about 0.1 to 30 seconds, or undergone a homogenisation step at a temperature of 45-98° C. where the beverage is to undergo a sterilising step at least 90° C. for a least at least 2 minutes.

In a twenty third aspect there is provided a beverage comprising (a) about 6-20% by weight protein in the form of a milk protein concentrate (MPC) which has undergone a heat treatment during its manufacture to denature about 50-100% by weight of whey protein in the MPC (b) 0-30° k by weight fat (c) 0.1-45% by weight of carbohydrate; and

wherein the beverage has undergone a homogenisation step at a temperature of about 70-98° C. and a UHT sterilising step, or wherein the beverage has undergone a homogenisation step at a temperature of 45-98° C. and a retort sterilising step.

In a twenty fourth aspect there is provided a beverage comprising (a) about 6-20% by weight protein in the form of a milk protein concentrate (MPC) which has undergone a heat treatment during its manufacture to denature about 50-100% by weight of whey protein in the MPC and has had the calcium content in the MPC depleted by about 2-50% by weight and (b) 0-30% by weight fat (c) 0.1-45% by weight of carbohydrate; and

wherein the beverage has undergone a homogenisation step at a temperature of about 70-98° C. and a UHT sterilising step, or wherein the beverage has undergone a homogenisation step at a temperature of 45-98° C. and a retort sterilising step.

In a twenty fifth aspect there is provided a beverage comprising (a) about 6-20% by weight protein in the form of a milk protein concentrate (MPC) which has undergone a heat treatment during its manufacture to denature about 50-100% by weight of whey protein in the MPC (b) 0-30% by weight fat (c) 0.1-45% by weight of carbohydrate; and

wherein the beverage has undergone a homogenisation step at a temperature of about 70-98° C. and a UHT sterilising step.

In a twenty sixth aspect there is provided a beverage comprising (a) about 6-20% by weight protein in the form of a milk protein concentrate (MPC) which has undergone a heat treatment during its manufacture to denature about 50-100% by weight of whey protein in the MPC and has had the calcium content in the MPC depleted by about 2-50% by weight and (b) 0-30% by weight fat (c) 0.1-45% by weight of carbohydrate; and

wherein the beverage has undergone a homogenisation step at a temperature of about 70-98° C. and a UHT sterilising step.

In a twenty seventh aspect there is provided a beverage comprising (a) about 6-20% by weight protein in the form of a milk protein concentrate (MPC) which has undergone a heat treatment during its manufacture to denature about 50-100% by weight of whey protein in the MPC (b) 0-30% by weight fat (c) 0.1-45% by weight of carbohydrate; and

wherein the beverage has undergone a homogenisation step at a temperature of 45-98° C. and a retort sterilising step.

In a twenty eighth aspect there is provided a beverage comprising (a) about 6-20% by weight protein in the form of a milk protein concentrate (MPC) which has undergone a heat treatment during its manufacture to denature about 50-100% by weight of whey protein in the MPC and has had the calcium content in the MPC depleted by about 2-50% by weight and (b) 0-30% by weight fat (c) 0.1-45% by weight of carbohydrate; and

wherein the beverage has undergone a homogenisation step at a temperature of 45-98° C. and a retort sterilising step.

In a twenty ninth aspect there is provided a beverage comprising (a) about 6-20% by weight protein in the form of a milk protein concentrate (MPC) which has undergone a heat treatment during its manufacture to denature about 50-100% by weight of whey protein in the MPC (b) 0-30% by weight fat (c) 0.1-45% by weight of carbohydrate; and

wherein the beverage has undergone a homogenisation step at a temperature of about 70-98° C. and a sterilising step at about 120 to 150° C. for about 0.1 to 30 seconds, or wherein the beverage has undergone a homogenisation step at a temperature of 45-98° C. and a sterilising step at least 90° C. for a least at least 2 minutes.

In a thirtieth aspect there is provided a beverage comprising (a) about 6-20% by weight protein in the form of a milk protein concentrate (MPC) which has undergone a heat treatment during its manufacture to denature about 50-100% by weight of whey protein in the MPC and has had the calcium content in the MPC depleted by about 2-50% by weight and (b) 0-30% by weight fat (c) 0.1-45% by weight of carbohydrate; and

wherein the beverage has undergone a homogenisation step at a temperature of about 70-98° C. and a sterilising step at about 120 to 150° C. for about 0.1 to 30 seconds, or wherein the beverage has undergone a homogenisation step at a temperature of 45-98° C. and a sterilising step at least 90° C. for a least at least 2 minutes.

For the avoidance of doubt the following embodiments concerning the beverage may apply to all of the beverage aspects above and the aspects below, where applicable in context.

In some embodiments, the beverage further undergoes a sterilising step after the homogenisation step.

In some embodiments, the sterilising step comprises heat treating the beverage.

In some embodiments sterilising step gives an Fo value of at least about 5, or at least about 3. Preferably the heat treatment has an Fo value of at least equivalent to 90° C. for 40 minutes, 121.1° C. for 3 minutes, 130° C. for 25 seconds, 140° C. for 2.5 seconds or 150° C. for 0.25 seconds.

In some embodiments the sterilising is carried out by UHT or retort.

In some embodiments the sterilising step comprises UHT heat treating the beverage at a temperature of about 120 to 150° C. for about 0.1 seconds to about 30 seconds. In some embodiments the sterilising step comprises UHT heat treating the beverage at a temperature of about 120 to 150° C. for about 0.5 seconds to about 30 seconds. In some embodiments the sterilising step comprises UHT heat treating the beverage at a temperature of about 120 to 150° C. for about 1 seconds to about 30 seconds. In some embodiments the sterilising step comprises UHT heat treating the beverage at a temperature of about 120 to 150° C. for about 3 seconds to about 30 seconds. In some embodiments the sterilising step comprises UHT heat treating the beverage at a temperature of about 120 to 150° C. for about 1 to about 10 seconds. In some embodiments the sterilising step comprises UHT heat treating the beverage at a temperature of about 120 to 150° C. for about 3 to about 10 seconds. In some embodiments the sterilising step comprises UHT heat treating the beverage at a temperature of about 120 to 150° C. for about 0.1 to about 7 seconds. In some embodiments the sterilising step comprises UHT heat treating the beverage at a temperature of about 120 to 150° C. for about 1 to about 7 seconds. In some embodiments the sterilising step comprises UHT heat treating the beverage at a temperature of about 120 to 150° C. for about 3 to about 7 seconds. In some embodiments the sterilising step comprises UHT heat treating the beverage at a temperature of about 120 to 150° C. for about 0.1 to about 5 seconds. In some embodiments the sterilising step comprises UHT heat treating the beverage at a temperature of about 120 to 150° C. for about 1 to about 5 seconds. In some embodiments the sterilising step comprises UHT heat treating the beverage at a temperature of about 120 to 150° C. for about 3 to 5 seconds.

In some embodiments the sterilising step comprises UHT heat treating the beverage at a temperature of about 140 to 150° C. for about 3 to 6 seconds.

In some embodiments the sterilising step comprises retort heat treating the beverage at a temperature of at least 90° C. for a least at least 2 minutes. In some embodiments the sterilising step comprises retort heat treating the beverage at a temperature of at least 90° C. for a least at least 5 minutes. In some embodiments the sterilising step comprises retort heat treating the beverage at a temperature of at least 90° C. for a least at least 10 minutes. In some embodiments the sterilising step comprises retort heat treating the beverage at a temperature of at least 115° C. for a least at least 2 minutes. In some embodiments the sterilising step comprises retort heat treating the beverage at a temperature of at least 115° C. for a least at least 5 minutes. In some embodiments the sterilising step comprises retort heat treating the beverage at a temperature of at least 115° C. for a least at least 10 minutes.

In some embodiments the sterilising step comprises retort heat treating the beverage at a temperature of about 120 to 150° C. for a least at least 5 minutes. In some embodiments the sterilising step comprises retort heat treating the beverage at a temperature of about 120 to 150° C. for a least at least 10 minutes.

In some embodiments the sterilising step comprises retort heat treating the beverage at a temperature of about 105 to 150° C. for about 5 to 60 minutes, about 105 to 150° C. for about 5 to 45 minutes, about 105 to 150° C. for about 5 to 30 minutes. In some embodiments the sterilising step comprises retort heat treating the beverage at a temperature of about 105 to 145° C. for about 5 to 60 minutes, about 105 to 145° C. for about 5 to 45 minutes, about 105 to 145° C. for about 5 to 30 minutes. In some embodiments the sterilising step comprises retort heat treating the beverage at a temperature of about 110 to 145° C. for about 5 to 60 minutes, about 110 to 145° C. for about 5 to 45 minutes, about 110 to 145° C. for about 5 to 30 minutes. In some embodiments the sterilising step comprises retort heat treating the beverage at a temperature of about 120 to 130° C. for about 5 to 60 minutes, about 120 to 130° C. for about 5 to 45 minutes, about 120 to 130° C. for about 5 to 30 minutes. In some embodiments the sterilising step comprises retort heat treating the beverage at a temperature of about 120 to 130° C. for about 10 to 20 minutes.

In some embodiments the beverage has less egg-type or sulphur-type smell and/or taste compared to a beverage made with an MPC that has not been heat treated.

In some embodiments the beverage has less egg-type or sulphur-type smell and/or taste compared to a beverage made with an MPC that has not been heat treated to denature about 50-100% by weight of the total whey protein.

In some embodiments the beverage has less egg-type or sulphur-type smell and/or taste compared to a beverage made with an MPC that has not been heat treated to denature about 50-100% by weight of the total whey protein.

In some embodiments the beverage has less egg-type or sulphur-type smell and/or taste compared to a beverage made with an MPC that has not been heat treated to denature about 50-100% by weight of the total whey protein and has not been calcium depleted by about 2-50% by weight.

In some embodiments the less egg-type or sulphur-type smell and/or taste is on initial opening of container containing beverage.

In some embodiments, the beverage is about 6-18% by weight protein. In some embodiments, the beverage is about 6-16% by weight protein. Alternatively, in some embodiments, the beverage is about 8-16% by weight protein. In some embodiments, the beverage is about 10-16% by weight protein. Alternatively, in some embodiments the beverage is about 8-18% by weight protein. In some embodiments the beverage is about 10-18% by weight protein.

In some embodiments, the MPC has about 70-100% denatured whey protein. In some embodiments, the MPC has about 80-90% denatured whey protein.

In some embodiments, the MPC has about 2-50% by weight calcium depletion. In some embodiments, the MPC has about 5-50% by weight calcium depletion. In some embodiments, the MPC has about 5-45% by weight calcium depletion. In some embodiments, the MPC has about 5-30° k by weight calcium depletion. In some embodiments, the MPC has about 5-20% by weight calcium depletion. In some embodiments, the MPC has about 10-45% by weight calcium depletion. In some embodiments, the MPC has about 10-20% by weight calcium depletion. In some embodiments, the MPC has about 10-15% by weight calcium depletion.

In some embodiments, calcium content of the MPC is about 2.1 to 1.1%w/w of calcium. In some embodiments, calcium content of the MPC is about 2.1 to 1.8%w/w of calcium.

In some embodiments, the MPC has about 2.0-2.6 g of calcium per 100 g of protein. In some embodiments, the MPC has about 2.2-2.6 g of calcium per 100 g of protein, about 2.3-2.6 g of calcium per 100 g of protein, about 2.3-2.5 g of calcium per 100 g of protein, about 2.4-2.5 g of calcium per 100 g of protein.

In some embodiments, the beverage comprises about 0.1-15% w/w fat. In some embodiments, the beverage comprises about 0.5-10% w/w fat.

In some embodiments the fat is oil. In some embodiments the oil is vegetable oil.

In some embodiments, the beverage comprises about 0.5-45% w/w carbohydrate. In some embodiments the beverage comprises about 0.5 to 30% w/w carbohydrate. In some embodiments the beverage comprises about 1% to 30% w/w carbohydrate. In some embodiments the beverage comprises about 20-30% w/w carbohydrate.

In some embodiments the carbohydrate is sucrose and/or maltodextrin. In some embodiments the carbohydrate is sucrose and maltodextrin.

In some embodiments, the beverage further comprises an emulsifier.

In some embodiments, the beverage further comprises about 0.001-10% w/w emulsifier. In some embodiments, the beverage further comprises about 0.001-5% w/w emulsifier. In some embodiments, the beverage further comprises about 0.01-2% w/w emulsifier. In some embodiments, the beverage further comprises about 0.05-2% w/w emulsifier. In some embodiments, the beverage further comprises about 0.1-1% w/w emulsifier.

In some embodiments, the emulsifier is the selected from any one or more of mono- and di-glycerides, polysorbate (for example Tween 20, 40, 60 or 80), dairy derived phospholipids e.g. lecithin or dairy derived phospholipid, citric acid esters of mono- and diglycerides of fatty acids (CITREM), sucrose esters of fatty acids, starch sodium octenyl succinate, mono- and di-acetylated tartaric acid esters of mono- and diglycerides (DATEM), sodium stearoyl lactylate (SSL), ethoxylated mono- and diglycerides, propylene glycol mono- and diesters of fats and fatty acids (PGME), glyceryl-lacto esters of fatty acids (LACTEM). In some embodiments the emulsifier is DATEM.

In some embodiments the fat, carbohydrate and/or emulsifier are added prior to step (b). In some embodiments the fat, carbohydrate and/or emulsifier are added in step (a).

In some embodiments, the pH of the beverage is about 6 to about 8.

In some embodiments, the beverage further undergoes a further homogenizing step after the sterilising step.

In some embodiments, the further homogenizing step is carried out under aseptic conditions.

In some embodiments, the beverage further undergoes a freezing step to produce a frozen confectionary. In such embodiment there is provided a frozen confectionary.

In a thirty first aspect there is provided a milk protein concentrate (MPC) comprising at least one whey protein, wherein 50-100% of the whey protein is denatured, and wherein the calcium content of the (MPC) has been depleted by about 5-20% by weight.

In some embodiments, the calcium depletion is about 5-20% by weight. In some embodiments, the calcium depletion is about 5-18% by weight. In some embodiments, the calcium depletion is about 5-15% by weight. In some embodiments, the calcium depletion is about 8-15% by weight. In some embodiments, the calcium depletion is about 5-10% by weight.

In some embodiments, the MPC has about 70-100% denatured whey protein. In some embodiments, the MPC has about 80-90% denatured whey protein.

In some embodiments, the MPC is greater than 70%w/w milk protein. In some embodiments, the MPC is greater than 80%w/w milk protein. In some embodiments, the MPC is greater than 85%w/w milk protein.

In a thirty second aspect there is provided a milk protein concentrate (MPC) comprising at least one whey protein, wherein about 50-100% of the whey protein is denatured, and wherein calcium content of the MPC is about 2.0-2.6 g of calcium per 100 g of protein.

In some embodiments, the calcium content is about 2.2 -2.6 g of calcium per 100 g of protein. In some embodiments, the calcium content is about 2.3-2.6 g of calcium per 100 g of protein. In some embodiments, the calcium content is about 2.3-2.5 g of calcium per 100 g of protein. In some embodiments, the calcium content is about 2.4-2.5 g of calcium per 100 g of protein.

In some embodiments, the MPC has about 70-100% denatured whey protein. In some embodiments, the MPC has about 80-90% denatured whey protein.

In some embodiments, the MPC is greater than 70%w/w milk protein. In some embodiments, the MPC is greater than 80%w/w milk protein. In some embodiments, the MPC is greater than 85%w/w milk protein.

In a thirty third aspect there is provided a milk protein concentrate (MPC) comprising at least one whey protein, wherein about 50-100% of the whey protein is denatured, and wherein ionic calcium content of the MPC is about 1.0-1.5 mM when measured in an MPC solution at a concentration to give 12%w/w protein.

In some embodiments, the ionic calcium content of the MPC is about 1.1-1.5 mM when measured in an MPC solution at a concentration to give 12%w/w protein. In some embodiments, the ionic calcium content of the MPC is about 1.2-1.5 mM when measured in an MPC solution at a concentration to give 12%w/w protein. In some embodiments, the ionic calcium content of the MPC is about 1.2-1.4 mM when measured in an MPC solution at a concentration to give 12%w/w protein. In some embodiments, the ionic calcium content of the MPC is about 1.3-1.5 mM when measured in an MPC solution at a concentration to give 12%w/w protein.

In some embodiments, the MPC has about 70-100% denatured whey protein. In some embodiments, the MPC has about 80-90% denatured whey protein.

In some embodiments, the MPC is greater than 70%w/w milk protein. In some embodiments, the MPC is greater than 80%w/w milk protein. In some embodiments, the MPC is greater than 85%w/w milk protein.

In a thirty fourth aspect there is provided use of a milk protein concentrate (MPC) to reduce egg-type or sulphur-type smell and/or taste when the MPC is in an aqueous composition and the aqueous composition is heat treated,

wherein the MPC comprises at least one whey protein and about 50-100% by weight of the whey protein is denatured, and

wherein the reduction in egg-type or sulphur-type smell and/or taste is when compared to an MPC which has not been treated to denature the whey protein and is in a similar aqueous composition which is similarly heat treated.

In some embodiments, the MPC comprises about 70-100% denatured whey protein. In some embodiments, the MPC comprises about 80-90% denatured whey protein.

In some embodiments the aqueous composition has about 6-20% by weight protein from the milk protein concentrate (MPC), about 6-18% by weight protein, about 6-16% by weight protein, about 8-16% by weight protein, about 10-16% by weight protein, about 8-18% by weight protein, about 10-18% by weight protein.

In some embodiments the MPC is calcium content depleted by about 2-50% by weight. the MPC has about 5-50% by weight calcium depletion. In some embodiments, the MPC has about 5-45% by weight calcium depletion. In some embodiments, the MPC has about 5-30% by weight calcium depletion. In some embodiments, the MPC has about 5-20% by weight calcium depletion. In some embodiments, the MPC has about 10-45% by weight calcium depletion. In some embodiments, the MPC has about 10-20% by weight calcium depletion. In some embodiments, the MPC has about 10-15% by weight calcium depletion.

In some embodiments the MPC has a calcium content of about 2.1 to 1.1%w/w of calcium, about 2.1 to 1.8%w/w of calcium.

In some embodiments the calcium content of the MPC is preferably about 2.0-2.6 g of calcium per 100 g of protein, about 2.2-2.6 g of calcium per 100 g of protein, about 2.3-2.6 g of calcium per 100 g of protein, about 2.3-2.5 g of calcium per 100 g of protein, about 2.4-2.5 g of calcium per 100 g of protein.

In some embodiments the aqueous composition is homogenised and heat treated at the same time. In some embodiments the aqueous composition is homogenised at a temperature of about 45-98° C., about 50-95° C., about 50-90° C°C., about 70-95° C., about 75-90° C., about 80-90° C.

In some embodiments, the aqueous composition is homogenised for about 1 second to about 5 minutes, about 1 second to 3 minutes, about 1 second to 2 minutes, about 1 second to 1 minute, about 15 to 30 seconds.

In some embodiments, aqueous composition is homogenised at high pressure.

In some embodiments, the total homogenising pressure is about 100 to about 1000 bars, about 100 to about 600 bars, about 150 to about 500 bars, about 200 to about 400 bars.

In some embodiments the heat treatment of the aqueous composition is high temperature sterilisation. In some embodiments the high temperature sterilisation is UHT. In some embodiments the high temperature sterilisation is retort.

In some embodiments the heat treatment is both heated homogenisation and high temperature sterilisation.

In some embodiments the reduction in egg-type or sulphur-type smell and/or taste is when compared to an aqueous composition made with an MPC that has not been treated to denature about 50-100% by weight of the total whey protein.

In some embodiments the reduction in egg-type or sulphur-type smell and/or taste is when compared to an aqueous composition made with an MPC that has not been treated to denature the whey protein and has not been calcium depleted.

In some embodiments the reduction in egg-type or sulphur-type smell and/or taste is when compared to an aqueous composition made with an MPC that has not been treated to denature about 50-100% by weight of the total whey protein and has not been calcium depleted by about 2-50% by weight.

In some embodiments the reduction in egg-type or sulphur-type smell and/or taste is on initial opening of container containing beverage.

Any of the aforementioned features or embodiments or aspects may be combined with one or more of the other features or embodiments or aspects as described herein.

The term “comprising” as used in this specification and claims means “consisting at least in part of”. When interpreting each statement in this specification and claims that includes the term “comprising”, features other than that or those prefaced by the term may also be present. Related terms such as “comprise” and “comprises” are to be interpreted in the same manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

As used herein the term “and/or” means “and” or “or”, or both.

As used herein “(s)” following a noun means the plural and/or singular forms of the noun.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

The disclosure consists in the foregoing and also envisages constructions of which the following gives examples only. Features disclosed herein may be combined into new embodiments of compatible components addressing the same or related inventive concepts.

### BRIEF DESCRIPTION OF THE FIGURES

Preferred embodiments of the disclosure will be described by way of example only and with reference to the following drawings.

FIG. 1 shows an example of a process to make the MPC

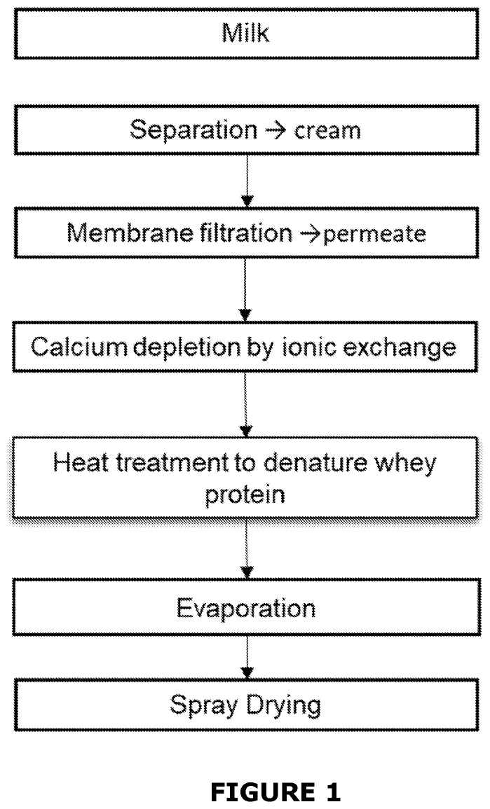

FIG. 2 shows an example of a process to make the beverage

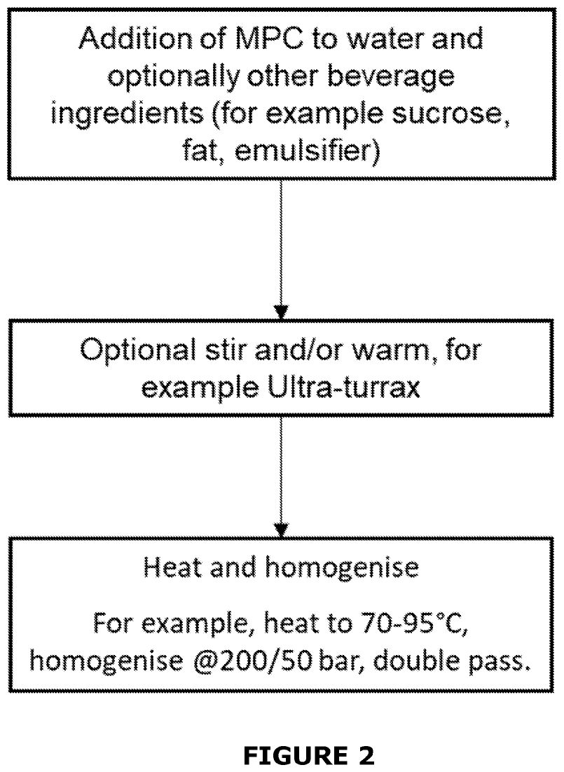

### DETAILED DESCRIPTION

Described herein is a method of making a beverage comprising (a) combining to make a beverage (i) water and (ii) about 6-20% by weight protein in the form of a milk protein concentrate (MPC) which has been heat treated to denature about 50-100% by weight of the total whey protein; and (b) homogenising the beverage at a temperature of about 45-98° C.

Further or alternatively described herein is a method of making a beverage comprising: (a) combining (i) water and (ii) about 6-20% by weight protein in the form of a milk protein concentrate (MPC) which has been heat treated to denature about 50-100% by weight of the total whey protein and which has the calcium content depleted by about 2-50% by weight; and (b) homogenising at a temperature of about 70-95° C.

Further or alternatively described herein is a method of making a beverage comprising (a) combining to make a beverage (i) water and (ii) about 6-20% by weight protein in the form of a milk protein concentrate (MPC) which has been heat treated to denature about 50-100% by weight of the total whey protein; and (b) homogenising the beverage at a temperature of about 70-98° C.

Further or alternatively described herein is a method of making a beverage comprising (a) combining to make a beverage (i) water and (ii) about 6-20% by weight protein in the form of a milk protein concentrate (MPC) which has been heat treated to denature about 50-100% by weight of the total whey protein; and (b) homogenising the beverage at a temperature of about 70-98° C. where the beverage is to undergo a UHT sterilising step, or homogenising at a temperature of about 45-98° C. where the beverage is to undergo a retort sterilising step.

Further or alternatively described herein is a method of making a beverage comprising (a) combining to make a beverage (i) water and (ii) about 6-20% by weight protein in the form of a milk protein concentrate (MPC) which has been heat treated to denature about 50-100% by weight of the total whey protein; and (b) homogenising the beverage at a temperature of about 70-98° C. where the beverage is to undergo a sterilising step at a temperature of about 120 to 150° C. for about 0.1 to 30 seconds, or homogenising at a temperature of about 45-98° C. where the beverage is to undergo a sterilising step at a temperature of at least 90° C. for a least at least 2 minutes.

Further or alternatively described herein is a method of making a beverage comprising (a) combining to make a beverage (i) water and (ii) about 6-20% by weight protein in the form of a milk protein concentrate (MPC) which has been heat treated to denature about 50-100% by weight of the total whey protein; (b) homogenising the beverage at a temperature of 70-98° C.; and (c) high temperature sterilising the beverage using UHT.

Further or alternatively described herein is a method of making a beverage comprising (a) combining to make a beverage (i) water and (ii) about 6-20% by weight protein in the form of a milk protein concentrate (MPC) which has been heat treated to denature about 50-100% by weight of the total whey protein; (b) homogenising the beverage at a temperature of 45-98° C.; and (c) high temperature sterilising the beverage using retort.

Further or alternatively described herein is a method of making a beverage comprising (a) combining to make a beverage (i) water and (ii) about 6-20% by weight protein in the form of a milk protein concentrate (MPC) which has been heat treated to denature about 50-100% by weight of the total whey protein; (b) homogenising the beverage at a temperature of 70-98° C.; and (c) high temperature sterilising the beverage at a temperature of about 120 to 150° C. for about 0.1 to 30 seconds.

Further or alternatively described herein is a method of making a beverage comprising (a) combining to make a beverage (i) water and (ii) about 6-20% by weight protein in the form of a milk protein concentrate (MPC) which has been heat treated to denature about 50-100% by weight of the total whey protein; (b) homogenising the beverage at a temperature of 45-98° C.; and (c) high temperature sterilising the beverage at a temperature of at least 90° C. for at least 2 minutes.

Further or alternatively described herein is a beverage comprising (a) about 6-20% by weight protein in the form of a milk protein concentrate (MPC) which has undergone a heat treatment during its manufacture to denature about 50-100% by weight of whey protein in the MPC (b) 0-30% by weight fat (c) 0.1-45% by weight of carbohydrate; and wherein the beverage has undergone a homogenisation step at a temperature of about 45-98° C.

Further or alternatively described herein is a beverage comprising (a) about 6-20% by weight protein in the form of a milk protein concentrate (MPC) which has undergone a heat treatment during its manufacture to denature about 50-100% by weight of whey protein in the MPC and has had the calcium content in the MPC depleted by about 2-50% by weight and (b) 0-30% by weight fat; (c) 1-45% by weight of carbohydrate; and wherein the beverage has undergone a homogenisation step at a temperature of about 70-98° C.

Further or alternatively described herein is a beverage comprising (a) about 6-20% by weight protein in the form of a milk protein concentrate (MPC) which has undergone a heat treatment during its manufacture to denature about 50-100% by weight of whey protein in the MPC (b) 0-30% by weight fat (c) 0.1-45% by weight of carbohydrate; and wherein the beverage has undergone a homogenisation step at a temperature of about 70-98° C. where the beverage is to undergo a UHT sterilising step, or undergone a homogenisation step at a temperature of 45-98° C. where the beverage is to undergo a retort sterilising step.

Further or alternatively described herein is a beverage comprising (a) about 6-20% by weight protein in the form of a milk protein concentrate (MPC) which has undergone a heat treatment during its manufacture to denature about 50-100% by weight of whey protein in the MPC (b) 0-30% by weight fat (c) 0.1-45% by weight of carbohydrate; and wherein the beverage has undergone a homogenisation step at a temperature of about 70-98° C. where the beverage is to undergo a sterilising step at about 120 to 150° C. for about 0.1 to 30 seconds, or undergone a homogenisation step at a temperature of 45-98° C. where the beverage is to undergo a sterilising step at least 90° C. for a least at least 2 minutes.

Further or alternatively described herein is a beverage comprising (a) about 6-20% by weight protein in the form of a milk protein concentrate (MPC) which has undergone a heat treatment during its manufacture to denature about 50-100% by weight of whey protein in the MPC (b) 0-30% by weight fat (c) 0.1-45% by weight of carbohydrate; and wherein the beverage has undergone a homogenisation step at a temperature of about 70-98° C. and a UHT sterilising step, or wherein the beverage has undergone a homogenisation step at a temperature of 45-98° C. and a retort sterilising step.

Further or alternatively described herein is a beverage comprising (a) about 6-20% by weight protein in the form of a milk protein concentrate (MPC) which has undergone a heat treatment during its manufacture to denature about 50-100% by weight of whey protein in the MPC (b) 0-30% by weight fat (c) 0.1-45% by weight of carbohydrate; and wherein the beverage has undergone a homogenisation step at a temperature of about 70-98° C. and a UHT sterilising step.

Further or alternatively described herein is a beverage comprising (a) about 6-20% by weight protein in the form of a milk protein concentrate (MPC) which has undergone a heat treatment during its manufacture to denature about 50-100% by weight of whey protein in the MPC (b) 0-30% by weight fat (c) 0.1-45% by weight of carbohydrate; and wherein the beverage has undergone a homogenisation step at a temperature of 45-98° C. and a retort sterilising step.

Further or alternatively described herein is a beverage comprising (a) about 6-20% by weight protein in the form of a milk protein concentrate (MPC) which has undergone a heat treatment during its manufacture to denature about 50-100% by weight of whey protein in the MPC (b) 0-30% by weight fat (c) 0.1-45% by weight of carbohydrate; and wherein the beverage has undergone a homogenisation step at a temperature of about 70-98° C. and a sterilising step at about 120 to 150° C. for about 0.1 to 30 seconds, or wherein the beverage has undergone a homogenisation step at a temperature of 45-98° C. and a sterilising step at least 90° C. for a least at least 2 minutes.

Further or alternatively described herein is a milk protein concentrate (MPC) comprising at least one whey protein, wherein 50-100% of the whey protein is denatured, and wherein the calcium content of the (MPC) has been depleted by about 5-20% by weight.

Further or alternatively described herein is a milk protein concentrate (MPC) comprising at least one whey protein, wherein about 50-100% of the whey protein is denatured, and wherein calcium content of the MPC is about of 2.0-2.6 g of calcium per 100 g of protein.

Further or alternatively described herein is a milk protein concentrate (MPC) comprising at least one whey protein, wherein about 50-100% of the whey protein is denatured, and wherein ionic calcium content of the MPC is about 1.0-1.5 mM when measured in an MPC solution at a concentration to give 12%w/w protein.

Further or alternatively described herein is use of a milk protein concentrate (MPC) to reduce egg-type or sulphur-type smell and/or taste when the MPC is in an aqueous composition and the aqueous composition is heat treated, wherein the MPC comprises at least one whey protein and about 50-100% by weight of the whey protein is denatured, and wherein the reduction in egg-type or sulphur-type smell and/or taste is when compared to an MPC which has not been treated to denature the whey protein and is in a similar aqueous composition which is similarly heat treated.

The present disclosure relates to ameliorating the malodour and/or undesired taste profile that results from heat homogenisation of an MPC containing beverage.

The step of heat homogenising a beverage (for example homogenising the beverage at a temperature of about 70-95° C.), is carried out to give a desired consistency while also lowering, keeping stable or at least retarding the growth of bacteria, particularly thermophilic bacteria. This is particularly important where the beverage is to be consumed by venerable consumers but is also generally beneficial to reduce risk of contamination. However, it has previously been found that heat homogenisation can result in malodour or undesirable taste profile of a beverage containing MPC, for example an “eggy” or sulphurous smell. While the malodour or taste profile may make no difference to the nutritional properties of the beverage, it is very important to consumers. A malodour or unappetising taste profile will discourage consumers of the beverage. This is particularly important where the beverage is being used for patients or the elderly to increase protein in the diet. The taste/smell is also very important to encourage repeat sales of a product, for example a sports recovery or muscle building product.

The present disclosure is concerned with reducing or at least ameliorating malodour or undesirable taste associated with heat homogenisation of an MPC in water and providing a beverage and/or MPC. The beverage disclosed herein, or a beverage made from an MPC disclosed herein preferably has an improved taste and/or smell profile compared to a beverage made with an MPC that has not been heat treated. Alternatively, provided herein is a use of a milk protein concentrate (MPC) to reduce egg-type or sulphur-type smell and/or taste when the MPC is in an aqueous composition and the aqueous composition is heat treated.

The reduction in egg-type or sulphur-type smell and/or taste is preferably when compared to a beverage/aqueous composition made with an MPC that has not been treated to denature the whey protein and is in aqueous composition at the same concentration and which is heat treated in the same way.

The reduction in egg-type or sulphur-type smell and/or taste is preferably when compared to a beverage/aqueous composition made with an MPC that has not been treated to denature the whey protein and has not been calcium depleted.

In some embodiments the beverage has less egg-type or sulphur-type smell and/or taste compared to a beverage made with an MPC that has not been heat treated to denature about 50-100% by weight of the total whey protein.

In some embodiments the beverage has less egg-type or sulphur-type smell and/or taste compared to a beverage made with an MPC that has not been heat treated to denature about 50-100% by weight of the total whey protein and has not been calcium depleted by about 2-50% by weight.

In some embodiments the less egg-type or sulphur-type smell and/or taste is on initial opening of container containing beverage.

### Protein/MPC

The beverage or aqueous composition contains 6-20% by weight protein or 6-20% by weight protein is combined in the method of making a beverage. Preferably, about 6-18% by weight protein, or about 6-16% by weight protein, about 8-16% by weight protein or about 10-16% by weight protein. Alternatively, about 8-18% by weight or about 10-18% by weight protein. The choice of amount of protein is generally guided by the use of the beverage. In some uses, such as sports drinks or medical drinks (to support patients or the elderly) higher protein levels may be beneficial.

The amount of protein in an MPC can vary, so the amount of MPC in the beverage can be selected based on the desired amount of protein in the beverage.

The term milk protein concentrate (MPC) refers to a milk protein product in which preferably greater than 70% weight of the non-fat solids are protein, or greater than 40%, preferably greater than 70%w/w, preferably greater than 80%w/w, preferably greater than 85%w/w is milk protein and the weight ratio of casein to whey proteins is between about 95:10 and about 50:50, preferably between 90:10 and 80:20. A MPC with greater than 90% milk protein is sometimes referred to as milk protein isolate (MPI). Where reference is made to an MPC, it should be taken to include an MPI, where applicable in context.

Whey protein may include beta lactoglobulin and/or alphalactalbumin. MPC can be produced by processes involving ultrafiltration and/or microfiltration either to prepare a stream enriched in casein or a stream enriched in whey protein, or a stream enriched in both casein and whey protein. Another process will include the blending of a stream of whey protein concentrate with skim milk with or without subsequent ultrafiltration.

The percentage of whey protein and casein in an MPC can vary, for example seasonally, or if the whey and casein are separated and then recombined the ratio can be set for the desired usage. The ratio/percentage of whey protein to casein in an MPC may be tested by various mean, for example the SDS gel method (see for example Anema and Klostermeyer (1997) Journal of agricultural and food chemistry 45(4) 1108-1115).

### Whey Denaturation

MPCs for use in the invention have a whey protein denaturation of at least 50%, preferably about 70-100%, or 80-90% by weight. The required whey protein denaturation can be achieved by heating, for example at a range of temperatures (for example about 75° C. to 120° C.) and time combinations based on whey protein denaturation kinetics (J. Agric. Food Chem. 1996, 44, 2, 422-428). Based on the temperature, the heating time can be selected to achieve the targeted whey protein denaturation, or alternatively, based on the heating time the required temperature can be selected. The heat treatment can be done at two different stages in the process of making the MPC, for example:

1. heat treating the milk before ultrafiltration and optional calcium depletion

2. after ultrafiltration and optional calcium depletion

There are two main types of heat treatment systems, direct and indirect. Example of direct heating systems are (i) Steam injection systems (steam injected into product), (ii) steam infusion systems (product introduced into a steam-filled vessel).

Examples of indirect systems can be based on (i) plate heat exchangers, (ii)tubular heat exchangers, (iii) scraped surface heat exchangers.

Heating can be done in a continuous, batch and/or semi-batch systems. Examples of batch/semi batch are (i) batch processing in autoclaves,(iii) hydrostatic vertical sterilizer,(iii) horizontal rotary valve-sealed sterilizer.

Whey protein denaturation can be measured using various methods, for example by HPLC (see Journal of Chromatography A, 878 (2000) 183-196).

The MPC is preferably dried to a moisture content of less than 5%. Or a water activity level than facilitates storage of the dry ingredient for several months without undue deterioration.

### Calcium Depletion

The MPC, MPC in the beverage, MPC in the aqueous composition, and/or MPC used in the method of making a beverage is preferably calcium depleted. Calcium depleted MPCs are MPCs in which the calcium content is lower than the corresponding non-depleted MPC. Without wishing to be bound by theory, it is believed calcium depletion further stabilises the MPC to processing, particularly heat processing steps and/or maintains a lower viscosity of the beverage during heat homogenising.

However, a high calcium depletion (for example, over above 60% by weight, particularly above 80% by weight) has been associated with undesirable sensory profiles in beverages, for example, an increase in saltiness and protein defects attributes such as “wet wool” smell and/or taste.

Preferably the MPC has about 2-50% by weight calcium depletion. Preferably the MPC has about 5-50% by weight calcium depletion. Preferably the MPC is less than about 50% by weight calcium depleted, or about 5-45% by weight calcium depleted, or about 5-30% by weight calcium depleted, or about 5-20% by weight calcium depletion, or about 10-45% by weight calcium depleted, or about 10-20% by weight calcium depleted, about 10-15% by weight calcium depleted.

The calcium content of the depleted MPC is preferably 2.1 to 1.1%w/w of calcium. The calcium content of the depleted MPC is preferably 2.1 to 1.8%w/w of calcium. By comparison a standard non-depleted MPC has a typical calcium level of 2.2%w/w, but may be lower, such as 2.1%w/w. This measurement of calcium content can be used as an alternative measurement to the % by weight calcium depletion in any of the aspects.

Alternatively, the calcium content of the MPC is preferably about 2.0-2.6 g of calcium per 100 g of protein. Preferably the calcium content of the MPC is about 2.2-2.6 g of calcium per 100 g of protein, about 2.3-2.6 g of calcium per 100 g of protein, about 2.3-2.5 g of calcium per 100 g of protein, about 2.4-2.5 g of calcium per 100 g of protein. For comparison, a non-depleted MPC has a calcium content of about 2.70 g of calcium per 100 g of protein. This measurement of calcium content can be used as an alternative measurement to the % by weight calcium depletion in any of the aspects.

Examples of preparation of a calcium depleted MPC can be found in WO01/41578.

The calcium depleted MPC may be prepared from a standard MPC by removing calcium ions, for example by a method chosen from at least one (1) cation exchange on an ion exchanger charged substantially with a single species of monovalent cation,(2) acidification to pH 4.6-7 with subsequent dialysis and/or ultrafiltration and/or diafiltration or (3) by addition of a chelating agent and/or binding a proportion of calcium ions with a chelating or sequestering agent.

The calcium-depleted MPC may also be prepared by providing a low fat milk solution, for example skim milk, in liquid form and removing the calcium ions therein by a method chosen from at least of (1) cation exchange on an ion exchange in a form bearing a monovalent cation species, or (2) acidification to pH 4.6-7 optionally with subsequent dialysis; and the concentrating the solution obtained by ultrafiltration, optionally with diafiltration, to form an MPC having at least 40% dry weight of protein.

If the method used to deplete the calcium is the addition of chelator, the total calcium will be 2.70 g per 100 g of protein typical of a non-depleted MPC, but the ionic calcium will be reduced. For example, for an MPC solution made up to a protein concentration of 12%w/w, the ionic calcium will range from 1.05 mM to 1.5 mM, in comparison the non-calcium depleted MPC will have an ionic calcium of 1.6 mM . Preferably, the ionic calcium content of the MPC is about 1.1-1.5 mM, about 1.2-1.5 mM, about 1.2-1.4 mM, or about 1.3-1.5 mM when measured in an MPC solution made up to a protein concentration of 12%w/w.

The ionic calcium is measured with a calcium ion combination electrode and the resultant potential was compared to that of four standard buffer solutions at the same ionic strength as that of the MPC solution tested, from which the free calcium ion concentration was derived.

The calcium depletion optimal level is based on the beverage formulation with two important parameters being the total solid and protein content. For example, at higher protein level (about 8 to 20%w/w), low fat (about 0 to 2%w/w) and low carbohydrate (about 0 to 5%w/w), a low calcium depletion is preferable (5 to 20%w/w). At higher total solids, for example protein levels (about 5 to 15%w/w), higher fat (about 5 to 20%w/w) and higher carbohydrate (about 10 to 35%w/w), a calcium depletion between 15 to 45%w/w is preferable. At low protein level (<8%w/w), and lower total solids (for example about 10%w/w) a wider range of calcium depletion (5 to 45%w/w) can be used. The total solids are the combined total % by weight of the solid components prior to them being combined in the water.

### Homogenisation

In step (b) of the method making a beverage, or where the beverage undergone a homogenisation step, or where the aqueous composition is homogenised, the homogenisation is preferably at a temperature of about 45-98° C., or 70-95° C. or 70-98° C., or the homogenising step is at about 75-90° C. or at about 80-90° C.

Preferably where the beverage/aqueous composition further undergoes a UHT sterilising step the homogenisation is at 70-98° C., or where the beverage/aqueous composition further undergoes a retort sterilising step the homogenisation is at 45-98° C.

Preferably homogenisation is carried out for about 1 second to about 5 minutes, about 1 second to 3 minutes, about 1 second to 2 minutes, about 1 second to 1 minute, about 15 to 30 seconds.

The beverage will usually be brought up to the required temperature prior to homogenisation. However, it will be dependent on how the homogenisation and heating is carried out, for example in line or batch processes.

Homogenisation can be carried out in a variety of equipment, for example a colloid mill, a high pressure homogeniser, or a sonic homogeniser, or rotor-stator homogenizer.

Where a high pressure homogeniser is used, preferably the homogenising pressure used is a total of about 100 to about 1000 bars, or about 100 to about 600 bars or about 150 to about 500 bars, or about 200 to about 400 bars. The homogenisation can be done in multiple passes, for example two passes. In this case the total pressure can be the sum of the pressure of the stages, for example in one pass, first stage 160 bar and second stage 40 bar (160/40 bar) gives a total of 200 bar. For example, two passes will give a total of 400 bar.

### Sterilisation

The method or beverage can further be sterilised, preferably after the heat homogenisation step. As noted previously, the heat homogenising step is useful for lowering, keeping stable or at least retarding the growth of bacteria, particularly thermophilic bacteria. This is particularly important where the beverage is to be consumed by venerable consumers but is also generally beneficial to reduce risk of contamination. However, to further decrease risk to consumers and/or increase shelf-life a further sterilisation step may also be carried out.

The sterilisation step can comprise heat treating the beverage to sterilise the beverage. Preferably high temperature sterilising is used. The high temperature sterilisation step is preferably carried out at about 90° C. to about 150° C. for about 0.25 second to about 60 minutes.

Preferably the high temperature sterilising step comprises heat treating the beverage at a temperature of at least about 90, 115, 120, 125, 130, 135, 136, 137, 138, 139, 140, 141, 142, 143, 144, 145, 146, 147, 148, 149 or at least about 150° C. for a period of at least about 0.1, 0.5, 1, 2, 3, 4, 5, 6, 7, 8, 9, 10, 12, 15, 20, 30, 40, 50, 60 seconds or at least about 1, 2, 3, 4, 5, 6, 7, 8, 9, 10 or at least about 60 minutes. Various ranges can be selected from between any of these values, for example, in various embodiments the high temperature sterilising step comprises heat treating the beverage at a temperature of at least about 120 to 150, 121 to about 150, 125 to about 150, 130 to about 150, 135 to about 150, 138 to about 150, 121 to about 145, 125 to about 145, 130 to about 145, 135 to about 145, or about 138 to about 145° C. for at least about 0.1 s to about 10 minutes, about 0.1 s to about 1 minute, about 0.1 s to about 30 s, about 0.5 s to about 30 s, about 1 s to about 30 s, about 3 s to about 30 s about 0.1 s to about 20 s, about 0.5 to about 20 s, about 1 to about 20 s, about 3 to about 20 s, about 0.1 to about 10 s, about 1 to about 10 s, about 3 to about 10 s, about 0.1 to about 7 s, about 1 to about 7 s, about 3 to about 7 s, about 0.1 to about 5 s, about 1 to about 5 s or about 3 s to about 5 s.

In various embodiments the high temperature sterilising step comprises heat treating the beverage at a temperature of at least about 115° C. for at least about 2 s, at least about 120° C. for at least about 2 s, at least about 125° C. for at least about 2 s, at least about 130° C. for at least about 1 s, at least about 135° C. for at least about 1 s, at least about 138° C. for at least about 1 s, at least about 130° C. for at least about 3 s, at least about 135° C. for at least about 3 s, at least about 138° C. for at least about 3 s, from about 130 to about 150° C. for at least about 1 s, from about 130 to about 150° C. for at least about 3 s, from about 135 to about 150° C. for at least about 1 s, from about 135 to about 150° C. for at least about 3 s, from about 138 to about 145° C. for at least about 1 s, from about 138 to about 145° C. for at least about 3 s, at least about 130° C. for about 1 s to about 10 s, at least about 135° 5 C for about 1 s to about 10 s, at least about 138° C. for about 1 s to about 10 s, from about 135 to about 150° C. for about 1 s to about 10 s, from about 138 to about 145° C. for about 1 s to about 10 s, from about 135 to about 150° C. for about 3 s to about 5 s, or from about 138 to about 145° C. for about 3 s to about 5 s.

The high temperature sterilising preferably gives an Fo value of at least about 5, or at least about 3. Preferably the heat treatment has an Fo value of at least equivalent to 90° C. for 40 minutes, 121.1° C. for 3 min, 130° C. for 25 s, 140° C. for 2.5s or 150° C. for 0.25 s

Preferably the high temperature sterilising is carried out by UHT or retort. For example, for ultra high temperature (UHT) the beverage is heated indirectly or directly (for example indirectly by means of heating coils or directly by live steam under pressure) at relatively high temperatures and generally held at this temperature for a few seconds, and this is usually followed by aseptic packaging. For retort the beverage is sterilized by sealing in a container (for example a can) which is then heated in an autoclave for minutes.

Where are retort sterilisation step is used, the heated homogenisation step may be carried out at a lower temperature, for example 45-98° C., while still providing the benefits of lowering, keeping stable or at least retarding the growth of bacteria.

Surprisingly, the improvement in the malodour and/or undesirable taste profile is still observed even after the sterilisation step (see Examples 2-4).

Described herein the present disclosure may relate to method of making a beverage comprising:(a) combining (i) water and (ii) about 6-20% by weight protein in the form of a milk protein concentrate (MPC) which has been heat treated to denature about 50-100% by weight of the total whey protein and which has the calcium content depleted by about 2-50° k by weight; and (b) homogenising at a temperature of about 70-98° C. where the beverage is to undergo a UHT sterilising step, or homogenising at a temperature of 45-98° C. where the beverage is to undergo a retort sterilising step.

Further or alternatively described herein the present disclosure may relate to a method of making a beverage comprising:(a) combining (i) water and (ii) about 6-20% by weight protein in the form of a milk protein concentrate (MPC) which has been heat treated to denature about 50-100% by weight of the total whey protein and which has the calcium content depleted by about 2-50% by weight; and (b) homogenising at a temperature of about 70-98° C. where the beverage is to undergo a sterilising step at about 120 to 150° C. for about 0.1 to 30 seconds, or homogenising at a temperature of 45-98° C. where the beverage is to undergo a sterilising step at about 100-150° C. for 5-20 minutes.

The UHT sterilisation step may be carried out to achieve the desired level of sterilisation, for example the UHT sterilisation step may be carried out at about 120 to 150° C. for about 0.1 seconds to about 30 seconds, or about 120 to 150° C. for about 0.5 seconds to about 30 seconds, or about 120 to 150° C. for about 1 seconds to about 30 seconds, or about 120 to 150° C. for about 3 seconds to about 30 seconds, or about 120 to 150° C. for about 1 to about 10 seconds, or about 120 to 150° C. for about 3 to about 10 seconds, or about 120 to 150° C. for about 0.1 to about 7 seconds, or about 120 to 150° C. for about 1 to about 7 seconds, or about 120 to 150° C. for about 3 to about 7 seconds, or about 120 to 150° C. for about 0.1 to about 5 seconds, or about 120 to 150° C. for about 1 to about 5 seconds, or about 120 to 150° C. for about 3 to 5 seconds, or about 140 to 150° C. for about 3 to 6 seconds.

Alternatively, a retort sterilisation step may be carried out to achieve the desired level of sterilisation, for example the retort sterilisation step may be carried out a temperature of at least 90° C. for a least at least 2 minutes, or at least 90° C. for a least at least 5 minutes, or at least 90° C. for a least at least 10 minutes, or at least 115° C. for a least at least 2 minutes, or at least 115° C. for a least at least 5 minutes, or at least 115° C. for a least at least 10 minutes, or about 120 to 150° C. for a least at least 5 minutes, or about 120 to 150° C. for a least at least 10 minutes, or about 105 to 150° C. for about 5 to 60 minutes, about 105 to 150° C. for about 5 to 45 minutes, about 105 to 150° C. for about 5 to 30 minutes, or about 105 to 145° C. for about 5 to 60 minutes, about 105 to 145° C. for about 5 to 45 minutes, about 105 to 145° C. for about 5 to 30 minutes or about 110 to 145° C. for about 5 to 60 minutes, about 110 to 145° C. for about 5 to 45 minutes, about 110 to 145° C. for about 5 to 30 minutes, or about 120 to 130° C. for about 5 to 60 minutes, about 120 to 130° C. for about 5 to 45 minutes, about 120 to 130° C. for about 5 to 30 minutes, or about 120 to 130° C. for about 10 to 20 minutes.

A further optional homogenisation step can also be carried out after the heat homogenisation and sterilisation. The further homogenizing step is preferably carried out under aseptic conditions.

The sterilised beverage is optionally cooled under aseptic conditions and/or aseptically packaged.

### Other Ingredients in Beverage

The beverage can optionally include other components in addition to the MPC. In particular, the beverage preferably comprises added fat and/or carbohydrate. The MPC generally comprises varying amounts of fat and/or carbohydrate depending on the MPC selected. The MPC can be selected and/or further fat and/or carbohydrate can be added to the beverage to give the desired levels.

The method and/or the beverage may comprise fat in the beverage. Preferably about 0.1-15% w/w fat, about 0.5-10% w/w fat. An example of a source of an additional source of fat is oil, particularly vegetable oil, for example palm oil.

The method and/or the beverage may comprise carbohydrate in beverage. Preferably, about 0.1-45% w/w carbohydrate, about 0.5-45% w/w, about 0.5 to 30% w/w, about 1% to 30% w/w, about 20-30% w/w. The additional source of carbohydrate will typically include digestible carbohydrates. The carbohydrate may comprise monosaccharides, disaccharides, oligosaccharides and polysaccharides and mixtures thereof. Oligosaccharides of glucose are typically used. A number of these are commercially available as maltodextrin (3-20 DE) or corn syrup for the longer chain carbohydrates (>20 DE). Non-digestible carbohydrates may also be included, for example, fructooligosaccharides, inulin, and galactooligosaccharides. Preferably the additional source of carbohydrate is sucrose and/or maltodextrin.

The method and/or beverage can optionally further comprise an emulsifier, for example, about 0.01 to about 2% w/w, about 0.05 to about 2% w/w, about 0.1 to about 1% w/w.

Preferably, the emulsifier is the selected from any one or more of mono- and di-glycerides, polysorbate (for example Tween 20, 40, 60 or 80), phospholipids (e.g. lecithin), dairy derived phospholipids, citric acid esters of mono- and diglycerides of fatty acids (CITREM), sucrose esters of fatty acids, starch sodium octenyl succinate, mono- and di-acetylated tartaric acid esters of mono- and diglycerides (DATEM), sodium stearoyl lactylate (SSL), ethoxylated mono- and diglycerides, propylene glycol mono- and diesters of fats and fatty acids (PGME), glyceryl-lacto esters of fatty acids (LACTEM).

The fat, carbohydrate and/or emulsifier are preferably added prior to step (b). The fat, carbohydrate and/or emulsifier are preferably added in step (a).

The beverage may further comprise additional protein sources, such as vegetable protein and/or collagen and/or these may be added in the method of making a beverage.

The beverage can optionally further comprise other components for the purposes of taste and/or texture. For example, the beverage can optionally comprise a sweetener, an antifoam, a chelator/stabilising agent, colouring, flavouring and/or nutritional ingredients.

The nutritional ingredients can be selected from any one or more of vitamins, minerals, amino acids, nucleotides and/or fatty acids (for example HUFA, PUFA).

The beverage preferably has a pH of about 6 to about 8. The pH can be adjusted with the addition of acid and/or base as required, for example the pH can be adjusted after the heat homogenising step.

### Frozen Confectionary

The method and/or beverage can further be frozen to make a frozen confectionary. The disclosure can therefore relate to a method of making a frozen confectionary comprising: (a) combining (i) water and (ii) about 6-20% by weight protein in the form of a milk protein concentrate (MPC) which has been heat treated to denature about 50-100% by weight of the total whey protein and which has the calcium content depleted by about 2-50% by weight; (b) homogenising at a temperature of about 70-95° C. and (c) cooling and freezing the homogenised composition.

Alternatively, the disclosure can therefore relate to a frozen confectionary comprising (a) about 6-20% by weight protein in the form of a milk protein concentrate (MPC) which has undergone a heat treatment during its manufacture to denature about 50-100% by weight of whey protein in the MPC and has had the calcium content in the MPC depleted by about 2-50% by weight and (b) 0-30% by weight fat; (c) 0.1-45% by weight of carbohydrate; and wherein the beverage has undergone a homogenisation step at a temperature of about 70-98° C.

For the avoidance of doubt the embodiments and steps described above in relation to the method of making a beverage and/or the beverage can further relate to the method of making a frozen confectionary and/or to the frozen confectionary where the context allows.

Where, in the foregoing description reference has been made to integers or components having known equivalents thereof, those integers are herein incorporated as if individually set forth.

Although the present disclosure has been described in terms of certain embodiments, other embodiments apparent to those of ordinary skill in the art also are within the scope of this disclosure. Thus, various changes and modifications may be made without departing from the spirit and scope of the disclosure. For instance, various components may be repositioned as desired. Moreover, not all of the features, aspects and advantages are necessarily required to practice the present disclosure. Accordingly, the scope of the present disclosure is intended to be defined only by the claims that follow.

### EXAMPLE

### 1. Example 1: Performance of Heat Treated MPC in a Beverage

MPC (A) (Fonterra Co-operative Group ltd., Auckland New Zealand) MPC (B) (Fonterra Co-operative Group ltd., Auckland New Zealand) and MPC (C) (Fonterra Co-operative Group ltd., Auckland New Zealand). The composition of the MPC ingredients are summarized in Table 1.

Palm oil—supplied by NZ Bakels Ltd., Auckland, New Zealand. Sucrose—supplied as Chelsea Extra Fine Sugar-Manufacturer: NZ Sugar Co Ltd., Auckland, New Zealand. DATEM 3502-supplied by Palsgaard, Denmark

TABLE 1

| | | MPC (B) | MPC (C) |
|---|---|---|---|
| | | (comparative | (comparative |
| Composition/100 g | MPC (A) | example) | example) |
| Protein (g) | 84.6 | 84.9 | 85 |
| Denatured whey | 86 | 0 | 29 |
| protein (%) | | | |
| Moisture (g) | 3.4 | 3.2 | 3.2 |
| Fat (g) | 1.2 | 1.3 | 1.3 |
| Lactose (g) | 3.6 | 3.3 | 3.3 |
| Ash (g) | 7.3 | 7.2 | 7.2 |
| Calcium (mg) | 1860 | 1890 | 1790 |
| | (14% calcium | (14% calcium | (18% calcium |
| | depleted) | depleted) | depleted) |
| Calcium (g) per | 2.20 | 2.23 | 2.11 |
| 100 g protein | | | |
| Sodium (mg) | 475 | 462 | 454 |

Beverages were prepared from the MPCs (MPC (A), MPC (B) and MPC (C)) according to the method detailed below (“Process to make beverage”).

### Process to Make Beverage

The following process was used to make test beverages:
1. 55° C. demineralized water (2.5 kg) was weighed into the jacketed mixing vessel.
2. MPC (0.4 kg), sucrose (34.5 g) and palm oil (14.4 g) and DATEM (6.6 g)(emulsifier) were added into continuously stirred water by Ultra-Turrax.
3. The prepared mixture was heated in a water bath to 85° C.
4. The prepared mixture was passed through a two-stage homogenizer (200/50 Bar) for about 30 seconds.
5. The homogenized mixture was cooled to 25° C. and the pH adjusted to target pH 7.0 with KOH.

The formulations of the beverages are shown in Table 2.

TABLE 2

| Ingredients | %(w/w) |
|---|---|
| Water | 84.6 |
| MPC (MPC (A), | 13.5 |
| MPC (B) or MPC (C)) | |
| Sucrose | 1.2 |
| Palm oil | 0.5 |
| DATEM | 0.2 |

The make-up of the protein, fat and carbohydrate in the beverages is shown in Table 3.

TABLE 3

| Ingredients | Concentration (g/100 g) |
|---|---|
| Protein | 11.4 |
| Carbohydrate | 1.6 |
| Fat | 0.8 |

The viscosity of the beverages was measured within a day of the homogenization. Viscosity was measured at 20° C., at 60 rpm using a Brookfield viscosimeter . The results are shown in Table 4.

TABLE 4

| | | MPC (B) | MPC (C) |
|---|---|---|---|
| | | (comparative | (comparative |
| | MPC (A) | example) | example) |
| Viscosity at 60 rpm (cP) | 19 | 34 | 33 |

The organoleptic properties of the final beverages were evaluated within a day of the homogenization. Each final beverage was evaluated by 4 panellists and ranked by strength of eggy odour. Each beverage was evaluated by 4 to 5 panellists (total 9 panellists, 5 samples/panellist) and ranked by strength of odour. Highest whey denatured MPC (MPC (A), 14% Ca depleted, 85% denatured whey protein) has less eggy unpleasant odour than the MPC that (1) did not have denatured whey protein (MPC (B), 14% Ca depleted, 0% denatured whey protein) and (2) did have low whey protein denaturation(MPC (C), 14% Ca depleted, 29% denatured whey protein) after homogenization at 85° C. A ranking of the eggy odour scores is shown in Table 5:

TABLE 5

| Temperature of | |
|---|---|
| homogenisation step | Ranking of eggy smell (low to high) |
| 85° C. | MPC(A) < MPC(C) < MPC (B) |

### 2. Example 2: Performance of Heat Treated MPC in a Homogenized (85° C.) and Retort Beverage

MPC (D) (Fonterra Co-operative Group ltd., Auckland New Zealand) MPC (E) (Fonterra Co-operative Group ltd., Auckland New Zealand) and MPC (F) (Fonterra Co-operative Group ltd., Auckland New Zealand). The composition of the MPC ingredients are summarized in Table 1.

Canola oil—supplied by NZ Bakels Ltd., Auckland, New Zealand. Sucrose—supplied as Chelsea Extra Fine Sugar-Manufacturer: NZ Sugar Co Ltd., Auckland, New Zealand. Lecithin Metarin-supplied by Cargill.

TABLE 1

| | MPC (D) | MPC (E) | |
|---|---|---|---|
| | (comparative | (comparative | |
| Composition/100 g | example) | example) | MPC (F) |
| Protein (g) | 81.3 | 80.2 | 80.3 |
| Denatured whey | 0 | 0 | 76 |
| protein (%) | | | |
| Moisture (g) | 5.7 | 5.8 | 5.8 |
| Fat (g) | 1.6 | 1.3 | 1.3 |
| Lactose (g) | 4.6 | 5.1 | 5.1 |
| Ash (g) | 6.8 | 7 | 6.8 |
| Calcium (mg) | 2230 | 1940 | 1880 |
| | (0% Ca | (13% Ca | (16% Ca |
| | depleted) | depleted) | depleted) |
| Calcium (g) per | 2.74 | 2.42 | 2.34 |
| 100 g protein | | | |
| Sodium (mg) | 110 | 398 | 403 |

Beverages were prepared from the MPCs (MPC (D), MPC (E) and MPC (F)) according to the method detailed below (“Process to make beverage”).

### Process to Make Beverage

The following process was used to make test beverages:
1. MPC were dry blend with granular sugar and lecithin, weight detailed are provided in the table 7 below.
2. 55° C. demineralized water (quantity in kg in the table below) was weighed into the jacketed mixing vessel. Antifoam (8 g) was added.
3. The dry blend with MPC (D) or (E) or (F) were added into continuously stirred water by in line mixing with Ystral/Condi-TDS. Canola oil was then added. See Table 8.
4. The prepared mixture was passed through a in line two-stage homogenizer (200/50 Bar) for about 30 seconds at 85° C.
5. A subsample of the homogenized mixture was cooled to 25° C. and the pH adjusted to target pH 7.0 with KOH. The weight of each batch was then adjusted with water to obtain a final batch size of 80 kg.
6. The blend was then retorted at 122C for 15 minutes.

TABLE 2

| Dry Blend | Blend | Blend | Blend |
|---|---|---|---|
| Ingredients (kg) | with MPC (D) | with MPC (E) | with MPC (F) |
| MPC (F) | | | 13.950 |
| MPC (D) | 13.780 | | |
| MPC (E) | | 13.970 | |
| Granular sugar | 0.970 | 0.890 | 0.890 |
| Lecithin Metarin | 0.085 | 0.085 | 0.085 |

TABLE 3

| | Beverage | Beverage | Beverage |
|---|---|---|---|
| Ingredient (g) | with MPC (D) | with MPC (E) | with MPC (F) |
| Water | 62248 | 62068 | 62093 |
| Blend with MPC (F) | | | 14214 |
| Blend with MPC (D) | 14129 | | |
| Blend with MPC (E) | | 14234 | |
| Canola Oil | 475 | 515 | 510 |
| Antifoam | 8 | 8 | 8 |
| Water for TS | 3000 | 3000 | 3000 |
| adjustment | | | |
| Total batch check | 80000 | 80000 | 80000 |

The formulations of the beverages are shown in Table 4.

TABLE 4

| | MPC (D) | MPC (E) | MPC (F) |
|---|---|---|---|
| | beverage | beverage | beverage |
| Ingredients | %(w/w) | %(w/w) | %(w/w) |
| Water | 81.71 | 81.50 | 81.53 |
| MPC | 16.400 | 16.625 | 16.604 |
| Sucrose | 1.15 | 1.06 | 1.06 |
| Canola oil | 0.59 | 0.64 | 0.64 |
| Lecithin | 0.10 | 0.10 | 0.10 |

The make-up of the protein, fat and carbohydrate in the beverages is shown in Table 5.

TABLE 5

| Ingredients | Concentration (g/1000 g) |
|---|---|
| Protein | 13 |
| Carbohydrate | 1.0 |
| Fat | 1.9 |

The organoleptic properties of the final beverages were evaluated within a day of the homogenization. Each final beverage was evaluated by 8 panellists and ranked by strength of odour after initial evaluation (just after opening of the retort can), and subsequent (after 1 minute).Highest whey denatured MPC (MPC (F), has less eggy unpleasant odour than the 2 MPCs (D and E) that did not have denatured whey protein after homogenization at 85° C. and retort. A ranking of the eggy odour scores is shown in Table 6.

TABLE 6

| | Ranking of eggy smell (low to high) |
|---|---|
| Initial evaluation | MPC(F) (2/8) < MPC (E) (4/8)) < MPC (D) (7/8) |
| (on opening of the can) | |
| After one minute | MPC (F) (0/8) < MPC (E) (2/8) < MPC (D) (3/8) |

### 3. Example 3: Performance of Heat Treated MPC in a Homogenized (50° C.) and Retorted Beverage

MPC (D) (Fonterra Co-operative Group ltd., Auckland New Zealand) and MPC (F) (Fonterra Co-operative Group ltd., Auckland New Zealand). The composition of the MPC ingredients are summarized in Table 7.

Canola oil—supplied by NZ Bakels Ltd., Auckland, New Zealand. Sucrose—supplied as Chelsea Extra Fine Sugar-Manufacturer: NZ Sugar Co Ltd., Auckland, New Zealand. Lecithin Metarin-supplied by Cargill.

TABLE 7

| | MPC (D) | |
|---|---|---|
| | (comparative | |
| Composition/100 g | example) | MPC (F) |
| Protein (g) | 81.3 | 80.3 |
| Denatured whey | 0 | 76 |
| protein (%) | | |
| Moisture (g) | 5.7 | 5.8 |
| Fat (g) | 1.6 | 1.3 |
| Lactose (g) | 4.6 | 5.1 |
| Ash (g) | 6.8 | 6.8 |
| Calcium (mg) | 2230 | 1880 |
| | (0% calcium | (16% calcium |
| | depleted) | depleted) |
| Calcium (g) per | 2.74 | 2.34 |
| 100 g protein | | |
| Sodium (mg) | 110 | 403 |

Beverages were prepared from the MPCs (MPC (D), MPC (F)) according to the method detailed below (“Process to make beverage”).

### Process to Make Beverage

The following process was used to make test beverages:
1. 55° C. demineralized water (35 kg for MPC(D) and 32 kg for MPC(F) was weighed into the jacketed mixing vessel.
2. MPC (D) (7.4 kg) or MPC (F) (6.64 kg), sucrose (0.52 kg with MPC (D) and 0.42 kg with MPC (F)) and canola oil (0.27 kg for MPC (D) and 0.26 kg for MPC (F)) and lecithin (45 g for MPC (D) and 40 g for MPC (F)) (emulsifier) were added into continuously stirred water by in line mixing with Ystral/Condi-TDS.
4. The prepared mixture was passed through a in line two-stage homogenizer (200/50 Bar) for about 30 seconds at 50° C.
5. A subsample of the homogenized mixture was cooled to 25° C. and the pH adjusted to target pH 6.8 with KOH.
6.The blend was then retorted at 122° C. for 15 minutes.

The formulations of the beverages are shown in Table 8.

TABLE 8

| | MPC (D) | MPC (F) |
|---|---|---|
| | beverage | beverage |
| Ingredients | %(w/w) | %(w/w) |
| Water | 81.71 | 81.53 |
| MPC (MPC (D), | 16.40 | 16.60 |
| MPC (F)) | | |
| Sucrose | 1.15 | 1.06 |
| Canola oil | 0.59 | 0.64 |
| Lecithin | 0.10 | 0.10 |

The make-up of the protein, fat and carbohydrate in the beverages is shown in Table 9.

TABLE 9

| Ingredients | Concentration (g/100 g) |
|---|---|
| Protein | 13.3 |
| Carbohydrate | 1.0 |
| Fat | 1.9 |

The organoleptic properties of the final beverages were evaluated within a few days of the retort. Each final beverage was evaluated blind by 7 panellists and the panellist determined if they can detect the eggy odour after opening the retort can. Highest whey denatured MPC (MPC (F) has less eggy unpleasant odour than the MPC (D) that did not have denatured whey protein after homogenization at 70° C. and retort at 122° C. for 15 minutes. A ranking of the eggy odour scores is shown in Table 10.

TABLE 10

| Temperature of | |
|---|---|
| homogenisation step | Ranking of eggy smell (low to high) |
| 50° C. | MPC(F) (0/7) < MPC(D) (7/7) |

### 4. Example 4: Performance of Heat Treated MPC in a Homogenized (70C) and Retorted Beverage

MPC (D) (Fonterra Co-operative Group ltd., Auckland New Zealand) and MPC (G) (Fonterra Co-operative Group ltd., Auckland New Zealand). The composition of the MPC ingredients are summarized in Table 11.

Canola oil—supplied by NZ Bakels Ltd., Auckland, New Zealand. Sucrose—supplied as Chelsea Extra Fine Sugar-Manufacturer: NZ Sugar Co Ltd., Auckland, New Zealand. Lecithin Metarin-supplied by Cargill.

TABLE 11

| | MPC (D) | |
|---|---|---|
| | (comparative | |
| Composition/100 g | example) | MPC (G) |
| Protein (g) | 81.3 | 81.9 |
| Denatured whey | 0 | 50 |
| protein (%) | | |
| Moisture (g) | 5.7 | 5.9 |
| Fat (g) | 1.6 | 1.7 |
| Lactose (g) | 4.6 | 6.5 |
| Ash (g) | 6.8 | 7.3 |
| Calcium (mg) | 2230 | 1319 |
| | (0% calcium | (41% calcium |
| | depleted) | depleted) |
| Calcium per | 2.74 | 1.61 |
| 100 g protein | | |
| Sodium (mg) | 110 | 1106 |

Beverages were prepared from the MPCs (MPC (D), MPC (G)) according to the method detailed below (“Process to make beverage”).

### Process to Make Beverage

The following process was used to make test beverages:
1. 55° C. demineralized water (35 kg) was weighed into the jacketed mixing vessel.
2. MPC (D) (7.4 kg) or MPC (G) (7.32 kg), sucrose (0.52 kg with MPC (D) and 0.39 kg with MPC (G)) and canola oil (0.27 kgg) and lecithin (45 g) (emulsifier) were added into continuously stirred water by in line mixing with Ystral/Condi-TDS.
4. The prepared mixture was passed through a in line two-stage homogenizer (200/50 Bar) for about 30 seconds at 70° C.
5. A subsample of the homogenized mixture was cooled to 25° C. and the pH adjusted to target pH 6.8 with KOH.
6.The blend was then retorted at 122C for 15 minutes.

The formulations of the beverages are shown in Table 12.

TABLE 12

| | MPC (D) | MPC (G) |
|---|---|---|
| | beverage | beverage |
| Ingredients | %(w/w) | %(w/w) |
| Water | 81.71 | 81.87 |
| MPC | 16.40 | 16.27 |
| Sucrose | 1.15 | 1.06 |
| Canola oil | 0.59 | 0.64 |
| Lecithin | 0.10 | 0.10 |

The make-up of the protein, fat and carbohydrate in the beverages is shown in Table 13.

TABLE 13

| Ingredients | Concentration (g/100 g) |
|---|---|
| Protein | 13.3 |
| Carbohydrate | 1.0 |
| Fat | 1.9 |

The organoleptic properties of the final beverages were evaluated within a few days of the retort. Each final beverage was evaluated blind by 7 panellists and the panellist determined if they can detect the eggy odour after opening the retort can. Highest whey denatured MPC (MPC (G) has less eggy unpleasant odour than the MPC (D)that did not have denatured whey protein and didn't have whey protein denaturation after homogenization at 70° C. and retort at 122c for 15 minutes. A ranking of the eggy odour scores is shown in Table 14.

TABLE 14

| Temperature of | |
|---|---|
| homogenisation step | Ranking of eggy smell (low to high) |
| 70° C. | MPC(G) (0/7) < MPC(D) (6/7) |

### 5. Example 5: Preparation of Calcium Depleted, and Heat Treated MPC

### Process to Make MPC

The following process was used to make MPC with reduced calcium and denatured whey protein:
1. 55 L of MPC85 retentate was diluted to 100L with water to give a 10% total solids solution (with a calcium level of 0.22%w/w and a protein concentration of 8.5%w/w).
2. 85L was stored at 5° C. in a tank A.
3. 15L was reduced to pH 5.9 by adding lactic acid and run it through a small ionic exchange column (2L Amberlite FPC14(Na)) to obtain a calcium level of 0.03% w/w.
4. Tank A and tank B content were blended to obtain a MPC with a reduced calcium level of 0.19%w/w and a protein concentration of 8.5%w/w.
5. 50 L of the blend was heat treated at 80° C. and held for 2 min (MPC 1) by a tubular heat exchanger+hold tube and the second 50L of the blend was heat treated at 80° C. and held for 1 min (MPC 2).

The percentage denaturation and calcium levels of the MPC are given in Table 20.

TABLE 20

| | MPC 1 | MPC 2 |
|---|---|---|
| Whey protein denaturation (%) | 82 | 68 |
| Ca depletion (%) | 14 | 14 |
| Ca level (g/100 g) | 0.19 | 0.19 |
| Ca level (g/100 g of protein) | 2.24 | 2.24 |

1. A milk protein concentrate (MPC) comprising at least one whey protein, wherein 50-100% of the whey protein is denatured, and wherein the calcium content of the (MPC) has been depleted by about 5-20% by weight.

2. The milk protein concentrate (MPC) of claim 1, wherein the calcium depletion is about 5-20% by weight, preferably about 5-18% by weight, preferably about 5-15% by weight, preferably about 8-15% by weight, preferably about 5-10% by weight.

3. The milk protein concentrate (MPC) of claim 1 or 2, wherein the MPC has about 70-100% denatured whey protein, preferably about 80-90% denatured whey protein.

4. The milk protein concentrate (MPC) of any one of claims 1 to 3, wherein the MPC is greater than 70%w/w milk protein, preferably greater than 80%w/w milk protein, preferably greater than 85%w/w milk protein.

5. A milk protein concentrate (MPC) comprising at least one whey protein, wherein about 50-100% of the whey protein is denatured, and wherein calcium content of the MPC is about of 2.0-2.6 g of calcium per 100 g of protein.

6. The milk protein concentrate (MPC) of claim 5, wherein the calcium content is about 2.2-2.6 g of calcium per 100 g of protein, preferably about 2.3-2.6 g of calcium per 100 g of protein, preferably about 2.3-2.5 g of calcium per 100 g of protein, preferably about 2.4-2.5 g of calcium per 100 g of protein.

7. The milk protein concentrate (MPC) of claim 5 or 6, wherein the MPC has about 70-100% denatured whey protein, preferably about 80-90% denatured whey protein.

8. The milk protein concentrate (MPC) of any one of claims 5 to 7, wherein the MPC is greater than 70%w/w milk protein, preferably the MPC is greater than 80%w/w milk protein, preferably the MPC is greater than 85%w/w milk protein.

9. Use of a milk protein concentrate (MPC) to reduce egg-type or sulphur-type smell and/or taste when the MPC is in an aqueous composition and the aqueous composition is heat treated,
wherein the MPC comprises at least one whey protein and about 50-100% by weight of the whey protein is denatured, and
wherein the reduction in egg-type or sulphur-type smell and/or taste is when compared to an MPC which has not been treated to denature the whey protein and is in a similar aqueous composition which is similarly heat treated.

10. The use of claim 9 wherein the MPC comprises about 70-100% denatured whey protein, preferably about 80-90% denatured whey protein.

11. The use of claim 9 or 10 wherein the aqueous composition has about 6-20% by weight protein from the milk protein concentrate (MPC), preferably about 6-18% by weight protein, preferably about 6-16% by weight protein, preferably about 8-16% by weight protein, preferably about 10-16% by weight protein, preferably about 8-18% by weight protein, about 10-18% by weight protein.

12. A method of making a beverage comprising:
(a) combining to make a beverage (i) water and (ii) about 6-20% by weight protein in the form of a milk protein concentrate (MPC) which has been heat treated to denature about 50-100% by weight of the total whey protein; and
(b) homogenising the beverage at a temperature of about 45-98° C.

13. The method of claim 12, wherein the homogenising step is at about 70-95° C.

14. The method of claim 12 or 13 wherein the MPC is about 2-50% by weight calcium depleted.

15. A method of making a beverage comprising:
(a) combining to make a beverage (i) water and (ii) about 6-20% by weight protein in the form of a milk protein concentrate (MPC) which has been heat treated to denature about 50-100% by weight of the total whey protein and which has the calcium content depleted by about 2-50% by weight; and
(b) homogenising the beverage at a temperature of about 70-98° C. where the beverage is to undergo a UHT sterilising step, or homogenising at a temperature of 45-98° C. where the beverage is to undergo a retort sterilising step.

16. The method of any one of claims 12 to 14 or claim 15, wherein about 6-18% by weight protein is combined, preferably about 6-16% by weight, preferably about 8-16% by weight, preferably about 10-16% by weight preferably about 8-18% by weight, preferably about 10-18% by weight.

17. The method any one of claims 12 to 14 or claim 15 or 16, wherein the MPC has about 70-100% denatured whey protein, preferably about 80-90% denatured whey protein.

18. The method of any one of claims 12 to 14 or claims 15 to 17, wherein the MPC has about 5-50% by weight calcium depletion, preferably about 5-45% by weight calcium depletion, preferably about 5-30% by weight calcium depletion, preferably about 5-20% by weight calcium depletion, preferably about 10-45% by weight calcium depletion, preferably about 10-20% by weight calcium depletion, preferably about 14% by weight calcium depletion.

19. The method of any one of claims 12 to 14 or claims 15 to 18, wherein in step (b) the beverage is homogenised for about 1 second to about 5 minutes, preferably about 1 second to 3 minutes, preferably about 1 second to 2 minutes, preferably about 1 second to 1 minute, preferably about 15 to 30 seconds.

20. The method of any one of claims 12 to 14 or claims 15 to 19, wherein the method further comprises the addition of fat to the beverage, preferably the method further comprises the addition of fat such that the beverage is about 0.1-15% w/w fat, preferably the method further comprises the addition of fat such that the beverage is of about 0.5-10% w/w fat.

21. The method of any one of claims 12 to 14 or claims 15 to 20, wherein the method further comprises the addition of carbohydrate to the beverage, preferably the method further comprises the addition of carbohydrate such that the beverage is about 0.1-45% w/w carbohydrate, preferably the method further comprises the addition of carbohydrate such that the beverage is about 0.5-45% w/w carbohydrate, preferably the method further comprises the addition of carbohydrate such that the beverage is about 0.5 to 30% w/w carbohydrate, preferably the method further comprises the addition of carbohydrate such that the beverage is less than about 1% to 30% w/w carbohydrate, preferably the method further comprises the addition of carbohydrate such that the beverage is about 20-30% w/w carbohydrate.

22. The method of any one of claims 12 to 14 or claims 15 to 21, wherein the method further comprises a sterilising step after carried out after step (b).

23. The method of any one of claims 15 to 22 where in the sterilising step comprises UHT heat treating the beverage at a temperature of about 120 to 150° C. for about 0.1 seconds to about 30 seconds.

24. The method of any one of claims 15 to 22 where in the sterilising step comprises retort treatment at least 90° C. for at least 2 minutes.

25. The method of any one of claims 12 to 14 or claims 15 to 24, wherein the method further comprises freezing the beverage to make a frozen confectionary.

26. A beverage comprising (a) about 6-20% by weight protein in the form of a milk protein concentrate (MPC) which has undergone a heat treatment during its manufacture to denature about 50-100% by weight of whey protein in the MPC (b) 0-30% by weight fat (c) 0.1-45% by weight of carbohydrate; and
wherein the beverage has undergone a homogenisation step at a temperature of about 45-98° C.

27. The beverage as claimed in claim 26 wherein the beverage has undergone a homogenisation step at a temperature of about 70-98° C.

28. A beverage comprising (a) about 6-20% by weight protein in the form of a milk protein concentrate (MPC) which has undergone a heat treatment during its manufacture to denature about 50-100% by weight of whey protein in the MPC and has had the calcium content in the MPC depleted by about 2-50% by weight and (b) 0-30% by weight fat (c) 0.1-45% by weight of carbohydrate; and
wherein the beverage has undergone a homogenisation step at a temperature of about 70-98° C. where the beverage is to undergo a UHT sterilising step, or undergone a homogenisation step at a temperature of 45-98° C. where the beverage is to undergo a retort sterilising step.

29. The beverage of claim 26 or 27 or claim 28, wherein the beverage is about 6-18% by weight protein, preferably about 6-16% by weight protein, preferably about 8-16% by weight protein, preferably about 10-16% by weight protein, preferably about 8-18% by weight protein, preferably about 10-18% by weight protein.

30. The beverage of any one of claim 26 or 27 or claim 28 or 29, wherein the MPC has about 70-100% denatured whey protein, preferably about 80-90% denatured whey protein.

31. The beverage of any one of claim 26 or 27 or claims 28 to 30, wherein the MPC has about 5-50% by weight calcium depletion, preferably about 5-45% by weight calcium depletion, preferably about 5-30% by weight calcium depletion, preferably about 5-20% by weight calcium depletion, preferably about 10-45% by weight calcium depletion, preferably about 10-20% by weight calcium depletion, preferably about 14% by weight calcium depletion.

32. The beverage of any one of claim 26 or 27 or claims 28 to 31, wherein the beverage comprises about 0.1-15% w/w fat, preferably about 0.5-10% w/w fat.

33. The beverage of any one of claim 26 or 27 or claims 28 to 32, wherein the beverage comprises about 0.5-45% w/w carbohydrate, preferably about 0.5 to 30% w/w carbohydrate, preferably about 1% to 30% w/w carbohydrate, preferably about 20-30% w/w carbohydrate.

34. The beverage of any one of claim 26 or 27 or claims 28 to 33, wherein the beverage has undergone a homogenisation step for about 1 second to about 5 minutes, preferably about 1 second to 3 minutes, preferably about 1 second to 2 minutes, preferably about 1 second to 1 minute, preferably about 15 to 30 seconds, preferably at about 75-90° C., preferably at about 80-90° C.

35. The beverage of any one of claim 26 or 27 or claims 28 to 32, wherein the beverage has further undergone a sterilising step.

36. The beverage of any one of claims 28 to 35, wherein the beverage has undergone a homogenisation step at a temperature of about 70-98° C. and a UHT sterilising step.

37. The beverage of any one of claims 28 to 35, wherein the beverage has undergone a homogenisation step at a temperature of 45-98° C. and a retort sterilising step.

38. The beverage of any one of claim 26 or 27 or claims 28 to 37, wherein the beverage has further undergone a freezing step to produce a frozen confectionary.
